(19) United States
(12) Patent Application Publication
(10) Pub. No.: US 2025/0038898 A1
(43) Pub. Date: Jan. 30, 2025

(54) SEGMENT BASED FEEDBACK CODEBOOK

(71) Applicant: QUALCOMM Incorporated, San Diego, CA (US)

(72) Inventors: Jing SUN, San Diego, CA (US); Mostafa KHOSHNEVISAN, San Diego, CA (US); Jing JIANG, San Diego, CA (US)

(21) Appl. No.: 18/360,558

(22) Filed: Jul. 27, 2023

(51) Int. Cl. H04L 1/1867; H04L 1/1607

(52) U.S. Cl. CPC H04L 1/1867; H04L 1/1607

(57) ABSTRACT

Methods, systems, and devices for wireless communications are described. A segment based feedback codebook may lead to more efficient and responsive codebook generation for hybrid automatic-repeat/request (HARQ) acknowledgment reporting. A segment-based feedback codebook may support codebook generation where each bit in an acknowledgment/negative-acknowledgment (ACK/NACK) codebook may correspond to a segment of resources. A network entity may schedule a user equipment with one or more messages within one or more segments. The UE may generate one ACK/NACK bit for each segment, and a HARQ codebook transmitted in a physical uplink control channel reporting occasion may include the ACK/NACK bits corresponding to the messages in those segments. A segment may be a set of time domain resources.

### FIELD OF TECHNOLOGY

The following relates to wireless communications, including segment based feedback codebook.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support segment based feedback codebook. For example, the described techniques provide for a segment based hybrid automatic-repeat/request (HARQ) codebook for HARQ acknowledgment (HARQ-ACK) reporting.

A wireless communication system may support codebook generation where each bit in an acknowledgment/negative-acknowledgment (ACK/NACK) codebook may correspond to a segment of resources (e.g., a set of resources). For example, a segment may be a set of time domain resources. Additionally, or alternatively, a segment may correspond to a quantity of symbols or slots and may be fixed or non-uniform with respect to other segments.

In some instances, a network entity may schedule a user equipment (UE) with multiple messages (e.g., physical downlink shared channel (PDSCH) transmissions) in a single segment. In these instances, the UE may bundle feedback information for the multiple messages into one ACK/NACK bit. In some other instances, a single message may span over (e.g., include resources from) multiple segments. In these instances, the UE may generate a HARQ codebook with a quantity of ACK/NACK bits corresponding to the quantity of segments the message spans over. In other words, the UE may generate one ACK/NACK bit for each segment, and a HARQ codebook for a physical uplink control channel (PUCCH) reporting occasion may include the ACK/NACK bits corresponding to the messages in those segments.

In some cases, a UE may implement an intra-segment bundling check to reduce at last a portion of the ACK to NACK error when bundling. For example, the UE may determine the possibility of a message being scheduled but not detected, check a Start and Length Indicator Value (SLIV), identify a quantity of expected downlink grant downlink control information (DCI), or any combination thereof. Additionally, a UE may implement a segment based HARQ codebook in the case of a carrier aggregation (CA) operation (e.g., a network entity schedules multiple component carriers (CCs) to the UE over overlapping time resources and/or the network entity may communicate with the UE through any of the CCs).

A method for wireless communications by a UE is described. The method may include receiving control signaling to report feedback information for a segment of resources, the segment being associated with one bit of the feedback information including an acknowledgment bit or a negative-acknowledgment bit of a hybrid automatic repeat request feedback, generating a feedback codebook associated with a set of multiple segments based on the control signaling, and transmitting the feedback codebook for the set of multiple segments based on generating the feedback codebook, the feedback codebook including the one bit of the feedback information associated with the segment according to the feedback codebook.

A UE for wireless communications is described. The UE may include one or more memories storing processor executable code, and one or more processors coupled with the one or more memories. The one or more processors may individually or collectively operable to execute the code to cause the UE to receive control signaling to report feedback information for a segment of resources, the segment being associated with one bit of the feedback information including an acknowledgment bit or a negative-acknowledgment bit of a hybrid automatic repeat request feedback, generate a feedback codebook associated with a set of multiple segments based on the control signaling, and transmit the feedback codebook for the set of multiple segments based on generating the feedback codebook, the feedback codebook including the one bit of the feedback information associated with the segment according to the feedback codebook.

Another UE for wireless communications is described. The UE may include means for receiving control signaling to report feedback information for a segment of resources, the segment being associated with one bit of the feedback information including an acknowledgment bit or a negative-acknowledgment bit of a hybrid automatic repeat request feedback, means for generating a feedback codebook associated with a set of multiple segments based on the control signaling, and means for transmitting the feedback codebook for the set of multiple segments based on generating the feedback codebook, the feedback codebook including the one bit of the feedback information associated with the segment according to the feedback codebook.

A non-transitory computer-readable medium storing code for wireless communications is described. The code may include instructions executable by a processor to receive control signaling to report feedback information for a segment of resources, the segment being associated with one bit of the feedback information including an acknowledgment bit or a negative-acknowledgment bit of a hybrid automatic repeat request feedback, generate a feedback codebook associated with a set of multiple segments based on the control signaling, and transmit the feedback codebook for the set of multiple segments based on generating the feedback codebook, the feedback codebook including the one bit of the feedback information associated with the segment according to the feedback codebook.

Some examples of the method, devices, and non-transitory computer-readable medium described herein may further include operations, features, means, or instructions for receiving one or more grants scheduling one or more messages in the segment, where generating the feedback codebook may be based on receiving the one or more grants.

Some examples of the method, devices, and non-transitory computer-readable medium described herein may further include operations, features, means, or instructions for determining a quantity of messages scheduled for the resources that include the segment based on offsets between a time when the quantity of messages may be received and an uplink occasion to transmit the feedback information associated with the feedback codebook, where generating the feedback codebook may be based on determining the quantity of messages.

In some examples of the method, devices, and non-transitory computer-readable medium described herein, the one bit of the feedback information associated with the segment includes information for the quantity of the messages.

In some examples of the method, devices, and non-transitory computer-readable medium described herein, transmitting the feedback codebook may include operations, features, means, or instructions for transmitting the one bit of the feedback information including the acknowledgment bit if each of the quantity of messages may be successfully decoded.

In some examples of the method, devices, and non-transitory computer-readable medium described herein, transmitting the feedback codebook may include operations, features, means, or instructions for transmitting the one bit of the feedback information including the negative-acknowledgment bit if at least one of the quantity of messages fails to be successfully decoded.

In some examples of the method, devices, and non-transitory computer-readable medium described herein, generating the feedback codebook may include operations, features, means, or instructions for determining a discontinuity of values of downlink assignment index indicators received as part of grants and assigning a negative acknowledgement to the segment in the feedback codebook based on determining the discontinuity of the values.

Some examples of the method, devices, and non-transitory computer-readable medium described herein may further include operations, features, means, or instructions for receiving a grant for a first message to be communicated during the segment, the grant including a first downlink assignment index indicator associated with the segment, where generating the feedback codebook may be based on the first downlink assignment index indicator.

Some examples of the method, devices, and non-transitory computer-readable medium described herein may further include operations, features, means, or instructions for receiving a second grant for a second message to be communicated during the segment, the second grant including a second downlink assignment index indicator associated with the segment and different than the first downlink assignment index indicator and receiving a third grant for a third message to be communicated during the segment, the third grant including a third downlink assignment index indicator associated with the segment and different than the first downlink assignment index indicator and the second downlink assignment index indicator.

Some examples of the method, devices, and non-transitory computer-readable medium described herein may further include operations, features, means, or instructions for determining a start parameter and a length parameter for a message scheduled to be communicated via the resources that include the segment, where generating the feedback codebook may be based on determining the start parameter and the length parameter.

Some examples of the method, devices, and non-transitory computer-readable medium described herein may further include operations, features, means, or instructions for determining whether a quantity of grants received for the resources that include the segment satisfies a threshold, where generating the feedback codebook may be based on determining whether the quantity of grants received satisfies the threshold.

Some examples of the method, devices, and non-transitory computer-readable medium described herein may further include operations, features, means, or instructions for determining whether a message scheduled to be communicated via the resources that include the segment was not successfully detected, where generating the feedback codebook may be based on determining whether the message was not successfully detected.

Some examples of the method, devices, and non-transitory computer-readable medium described herein may further include operations, features, means, or instructions for receiving second control signaling including an indication of a maximum quantity of messages capable of being scheduled to be communicated via the resources that include the segment, where generating the feedback codebook may be based on receiving the second control signaling.

Some examples of the method, devices, and non-transitory computer-readable medium described herein may further include operations, features, means, or instructions for transmitting signaling to indicate a maximum quantity of messages that the UE can support being scheduled in the resources that include the segment, where receiving the second control signaling may be based on transmitting the signaling.

Some examples of the method, devices, and non-transitory computer-readable medium described herein may further include operations, features, means, or instructions for receiving second control signaling including an indication of a maximum quantity of grants capable of scheduling messages to be communicated via the resources that include the segment, where generating the feedback codebook may be based on receiving the second control signaling.

In some examples of the method, devices, and non-transitory computer-readable medium described herein, receiving the control signaling may include operations, features, means, or instructions for receiving a grant for a first message to be communicated during the segment, the grant including a message quantity indicator associated with a quantity of messages scheduled to be communicated via the resources that include the segment, where generating the feedback codebook may be based on the message quantity indicator.

In some examples of the method, devices, and non-transitory computer-readable medium described herein, receiving the control signaling may include operations, features, means, or instructions for receiving a grant for a first message to be communicated during the segment, the grant including a segment index indicator associated with the segment and a message quantity indicator associated with a quantity of messages scheduled to be communicated via the resources that include the segment and receiving a second grant for a second message to be communicated during the segment, the second grant including the segment index indicator and the message quantity indicator, where generating the feedback codebook may be based on the segment index indicator and the message quantity indicator.

In some examples of the method, devices, and non-transitory computer-readable medium described herein, the resources that include the segment may be defined over time domain resources and one or more component carriers of a set of multiple component carriers.

Some examples of the method, devices, and non-transitory computer-readable medium described herein may further include operations, features, means, or instructions for receiving second control signaling to report the feedback information for a second segment of resources, the resources that include the second segment may be defined over second time domain resources that at least partially overlaps with the time domain resources and at least one component carrier different than the one or more component carriers, where generating the feedback codebook may be based on the second control signaling.

Some examples of the method, devices, and non-transitory computer-readable medium described herein may further include operations, features, means, or instructions for generating a feedback codebook of dynamic length, where generating the feedback codebook may be based on generating the feedback codebook of dynamic length.

In some examples of the method, devices, and non-transitory computer-readable medium described herein, generating the feedback codebook of dynamic length may include operations, features, means, or instructions for receiving one or more grants scheduling one or more messages in the set of multiple segments, the one or more grants including a segment index indicator, determining a discontinuity of values of segment index indicators received as part of grants, and assigning a negative acknowledgement to at least one segment in the feedback codebook based on determining the discontinuity of the values.

In some examples of the method, devices, and non-transitory computer-readable medium described herein, a set of multiple messages may be received via the resources that include the segment.

In some examples of the method, devices, and non-transitory computer-readable medium described herein, the segment includes one or more slots, one or more portions of a slot, or a combination thereof.

In some examples of the method, devices, and non-transitory computer-readable medium described herein, a first size of a first segment may be different than a second size of a second segment.

In some examples of the method, devices, and non-transitory computer-readable medium described herein, the resources that include the segment may be defined by a slot index, a symbol index, or any combination thereof.

In some examples of the method, devices, and non-transitory computer-readable medium described herein, the resources that include the segment may be defined by a physical uplink control channel transmission occasion.

In some examples of the method, devices, and non-transitory computer-readable medium described herein, the resources that include the segment may be associated with a time domain, a frequency domain, or any combination thereof.

A method for wireless communications by a network entity is described. The method may include transmitting control signaling to report feedback information for a segment of resources, the segment being associated with one bit of the feedback information including an acknowledgment bit or a negative-acknowledgment bit of a hybrid automatic repeat request feedback and receiving a feedback codebook associated with a set of multiple segments based on the control signaling, the feedback codebook including the one bit of the feedback information associated with the segment according to the feedback codebook.

A network entity for wireless communications is described. The network entity may include one or more memories storing processor executable code, and one or more processors coupled with the one or more memories. The one or more processors may individually or collectively operable to execute the code to cause the network entity to transmit control signaling to report feedback information for a segment of resources, the segment being associated with one bit of the feedback information including an acknowledgment bit or a negative-acknowledgment bit of a hybrid automatic repeat request feedback and receive a feedback codebook associated with a set of multiple segments based on the control signaling, the feedback codebook including the one bit of the feedback information associated with the segment according to the feedback codebook.

Another network entity for wireless communications is described. The network entity may include means for transmitting control signaling to report feedback information for a segment of resources, the segment being associated with one bit of the feedback information including an acknowledgment bit or a negative-acknowledgment bit of a hybrid automatic repeat request feedback and means for receiving a feedback codebook associated with a set of multiple segments based on the control signaling, the feedback codebook including the one bit of the feedback information associated with the segment according to the feedback codebook.

A non-transitory computer-readable medium storing code for wireless communications is described. The code may include instructions executable by a processor to transmit control signaling to report feedback information for a segment of resources, the segment being associated with one bit of the feedback information including an acknowledgment bit or a negative-acknowledgment bit of a hybrid automatic repeat request feedback and receive a feedback codebook associated with a set of multiple segments based on the control signaling, the feedback codebook including the one bit of the feedback information associated with the segment according to the feedback codebook.

### BRIEF DESCRIPTION OF THE DRAWINGS

FIG. 1 shows an example of a wireless communications system that supports segment based feedback codebook in accordance with one or more aspects of the present disclosure.

FIG. 2 shows an example of a wireless communications system that supports segment based feedback codebook in accordance with one or more aspects of the present disclosure.

FIGS. 3A and 3B show examples of a physical downlink shared channel (PDSCH) grid that supports segment based feedback codebook in accordance with one or more aspects of the present disclosure.

FIG. 4 shows an example of a grid that supports segment based feedback codebook in accordance with one or more aspects of the present disclosure.

FIG. 5 shows an example of a grid that supports segment based feedback codebook in accordance with one or more aspects of the present disclosure.

FIGS. 6A and 6B show examples of a grid that supports segment based feedback codebook in accordance with one or more aspects of the present disclosure.

FIG. 7 shows an example of a grid that supports segment based feedback codebook in accordance with one or more aspects of the present disclosure.

FIG. 8 shows an example of a grid that supports segment based feedback codebook in accordance with one or more aspects of the present disclosure.

FIG. 9 shows an example of a process flow that supports segment based feedback codebook in accordance with one or more aspects of the present disclosure.

FIGS. 10 and 11 show block diagrams of devices that support segment based feedback codebook in accordance with one or more aspects of the present disclosure.

FIG. 12 shows a block diagram of a communications manager that supports segment based feedback codebook in accordance with one or more aspects of the present disclosure.

FIG. 13 shows a diagram of a system including a device that supports segment based feedback codebook in accordance with one or more aspects of the present disclosure.

FIGS. 14 and 15 show block diagrams of devices that support segment based feedback codebook in accordance with one or more aspects of the present disclosure.

FIG. 16 shows a block diagram of a communications manager that supports segment based feedback codebook in accordance with one or more aspects of the present disclosure.

FIG. 17 shows a diagram of a system including a device that supports segment based feedback codebook in accordance with one or more aspects of the present disclosure.

FIGS. 18 through 20 show flowcharts illustrating methods that support segment based feedback codebook in accordance with one or more aspects of the present disclosure.

### DETAILED DESCRIPTION

A wireless communications system may typically utilize hybrid automatic-repeat/request acknowledgment (HARQ-ACK) feedback to confirm that a device (e.g., a user equipment (UE)) has successfully received and decoded a transmission (e.g., message). The HARQ-ACK feedback report may include a feedback codebook (e.g., HARQ codebook). The UE may generate a HARQ codebook to include a series of bits based on the configuration of the transmission. For example, a network entity may schedule a UE with a downlink transmission (e.g., a message or a physical downlink shared channel (PDSCH) transmission). The UE may determine whether the message (e.g., PDSCH) was successfully received and decoded. The UE may then report an acknowledgment/negative-acknowledgment (ACK/NACK) bit for the message.

There may be multiple HARQ ACK/NACK codebook mechanisms (e.g., Type 1 codebook, Type 2 codebook, Type 3 codebook, etc.) and/or bundling mechanisms. For example, the UE may transmit the bundled ACK/NACK bits as a single bit (e.g., an ACK or a NACK bit). For instance, if all of the feedback bits in the bundled ACK/NACK bits are ACK bits, then the UE may transmit a single ACK bit. Otherwise (e.g., at least one of the bundled ACK/NACK bits is a NACK bit), the UE may transmit a single NACK bit. However, according to current techniques, a UE may bundle the ACK/NACK bits according to scheduled grants, which may not be a flexible and/or efficient process.

The described techniques provide for a segment based feedback codebook, which may lead to more efficient and responsive codebook generation for HARQ-ACK reporting. For example, a segment based feedback codebook may support codebook generation where each bit in an ACK/NACK codebook may correspond to a segment of resources (e.g., a set of resources). For example, a segment may be a set of time domain resources. Additionally, or alternatively, a segment may correspond to a quantity of symbols or slots (e.g., one or more slots, one or more sub-slots, etc.) and may be fixed or non-uniform (e.g., dynamic) with respect to other segments.

In some instances, a network entity may schedule a UE with multiple messages (e.g., PDSCH transmissions) in a single segment. In these instances, the UE may bundle feedback information for the multiple messages into one ACK/NACK bit. In some other instances, a single message may span over (e.g., include resources from) multiple segments. In these instances, the UE may generate a HARQ codebook with a quantity of ACK/NACK bits corresponding to the quantity of segments the message spans over. In other words, the UE may generate one ACK/NACK bit for each segment, and a HARQ codebook for a PUCCH reporting occasion may include the ACK/NACK bits corresponding to the messages in those segments.

In some cases, a UE may implement an intra-segment bundling check to reduce at last a portion of the ACK to NACK error when bundling. For example, the UE may determine the possibility of a message being scheduled but not detected, check a Start and Length Indicator Value (SLIV), identify a quantity of expected downlink grant downlink control information (DCI), or any combination thereof. Additionally, a UE may implement a segment based HARQ codebook in the case of a carrier aggregation (CA) operation (e.g., a network entity schedules multiple component carriers (CCs) to the UE over overlapping time resources and/or the network entity may communicate with the UE through any of the CCs).

Aspects of the disclosure are initially described in the context of wireless communications systems. Additional aspects of this disclosure are described in the context of grids and process flows. Aspects of the disclosure are further illustrated by and described with reference to apparatus diagrams, system diagrams, and flowcharts that relate to segment based feedback codebook.

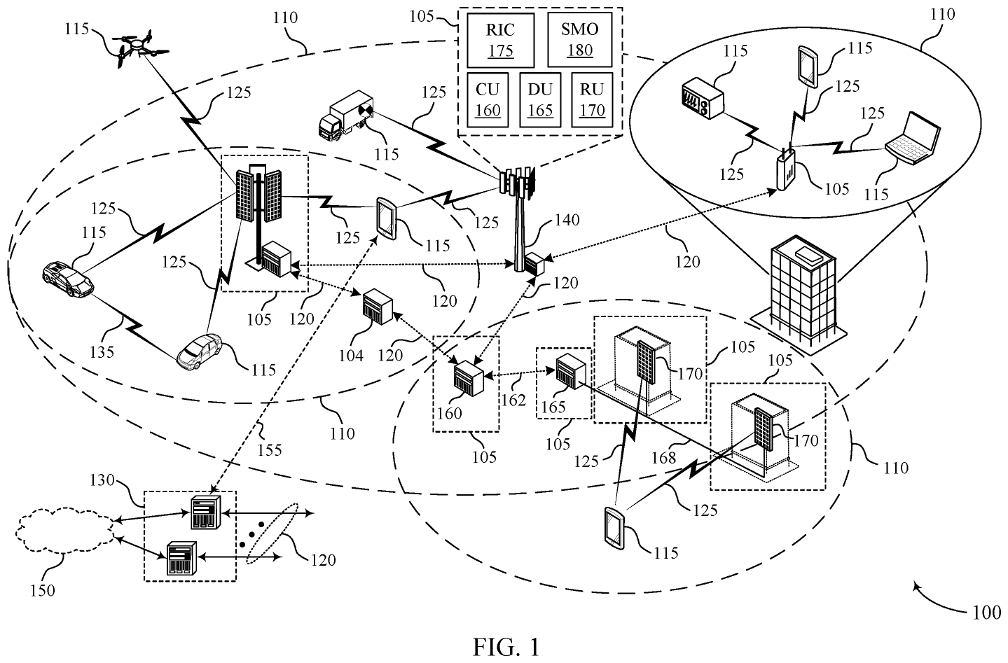

FIG. 1 shows an example of a wireless communications system 100 that supports segment based feedback codebook in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more Dus 165 or Rus 170, and the one or more Dus 165 or Rus 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more Rus 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more Dus 165 via a midhaul communication link 162 (e.g., F1, F1-c, F1-u), and a DU 165 may be connected to one or more Rus 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more Dus 165 or one or more Rus 170 may be partially controlled by one or more Cus 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by Dus 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include Dus 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support segment based feedback codebook as described herein. For example, some operations described as being performed by a UE 115 or a network entity 105 (e.g., a base station 140) may additionally, or alternatively, be performed by one or more components of the disaggregated RAN architecture (e.g., IAB nodes 104, Dus 165, Cus 160, Rus 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A wireless communications system may typically utilize HARQ-ACK feedback to confirm that a UE 115 has successfully received and decoded a transmission (e.g., message) from a network entity 105. The HARQ-ACK feedback report may include a feedback codebook (e.g., HARQ codebook). The UE 115 may generate a HARQ codebook to include a series of bits based on the configuration of the transmission. For example, a network entity 105 may schedule a UE 115 with a downlink transmission (e.g., a PDSCH transmission). The UE 115 may determine whether the message was successfully received and decoded. The UE 115 may then report an acknowledgment/negative-acknowledgment bit for that message.

There may be multiple HARQ ACK/NACK codebook mechanisms (e.g., Type 1 codebook, Type 2 codebook, Type 3 codebook, etc.). The UE 115 may generate a Type 1 codebook, in which case the feedback message my include an ACK or a NACK for each PDSCH occasion, resulting in robust feedback messages (e.g., but with a large amount of signaling overhead). The UE 115 may generate a Type 2 codebook based on additional bits included in DCIs to avoid missed DCIs. The additional bits may include a counter downlink assignment index (DAI) and/or a total DAI (e.g., corresponding to a common PUSCH or PDSCH). The counter DAI and the total DAI may indicate an order of DCIs, allowing the UE 115 to detect missed DCIs. However, such additional bits in the DCI may lead to increased signaling overhead. In some examples, the UE 115 may generate a Type 3 codebook. In such examples, a DCI may trigger a Type 3 codebook feedback message, in which case the DCI may trigger a transmission or retransmission of a full set of ACK/NACK bits (e.g., for all HARQ processes). For instance, in case of a NACK feedback message or a missed feedback message, the network entity 105 may trigger a Type 3 codebook feedback message.

In some cases, a UE 115 may implement one or more bundling schemes. In some examples, the UE 115 may perform spatial bundling for multi-carrier waveform (MCW) scenarios. In such examples a single DCI may grant up to two spatial codewords, and the two feedback bits may be bundled by configuration. In some examples, the UE 115 may perform time domain bundling (e.g., for multi-TTI grants). In such examples, the DCI may schedule multiple PDSCHs over different time domain TTIs. One feedback bit may be generated for each transport block (TB), and the feedback bits corresponding to all TBs from one DCI may bundle to one or multiple bits by configuration. In some examples, the UE 115 may perform multi-carrier grant cross carrier bundling. In such examples, a DCI may schedule multiple PDSCHs over different carriers. One feedback bit may be generated for each TB, and the feedback bits may correspond to all TBs from one DCI may be bundled to one or multiple bits by configuration.

A UE 115 may bundle the ACK/NACK bits (e.g., in a Type 1 codebook). That is, the UE 115 may transmit the bundled ACK/NACK bits as a single bit (e.g., an ACK or a NACK bit). For example, if all of the bits in the bundled ACK/NACK bits are ACK bits, then the UE 115 may transmit a single ACK bit. Otherwise (e.g., at least one of the bundled ACK/NACK bits is a NACK bit), the UE 115 may transmit a single NACK bit. However, according to current techniques, a UE 115 may bundle the ACK/NACK bits according to scheduled grants, which may not be a flexible or efficient process.

In some cases, a UE 115 may generate a segment based feedback codebook, which may lead to more efficient and responsive codebook generation for HARQ-ACK reporting. For example, a segment based feedback codebook may support codebook generation where each bit in an ACK/NACK codebook may correspond to a segment of resources (e.g., a set of resources). For example, a segment may be a set of time domain resources. Additionally, or alternatively, a segment may correspond to a quantity of symbols or slots (e.g., one or more slots, one or more sub-slots, etc.) and may be fixed or non-uniform (e.g., dynamic) with respect to other segments.

In some instances, a network entity 105 may schedule a UE 115 with multiple messages within a single segment. In these instances, the UE 115 may bundle feedback information for the multiple messages (e.g., PDSCHs) into one ACK/NACK bit. In some other instances, a single message may span over (e.g., include resources from) multiple segments. In these instances, the UE 115 may generate a HARQ codebook with a quantity of ACK/NACK bits corresponding to the quantity of segments the message spans over. In other words, the UE 115 may generate one ACK/NACK bit for each segment, and a HARQ codebook for a physical uplink control channel (PUCCH) reporting occasion may include the ACK/NACK bits corresponding to the messages in those segments.

In some cases, a UE 115 may implement an intra-segment bundling check to reduce at last a portion of the ACK to NACK error when bundling. For example, the UE 115 may determine the possibility of a message being scheduled but not detected, check a SLIV, identify a quantity of expected downlink DCI, or any combination thereof. Additionally, a UE may implement a segment based HARQ codebook in the case of a CA operation.

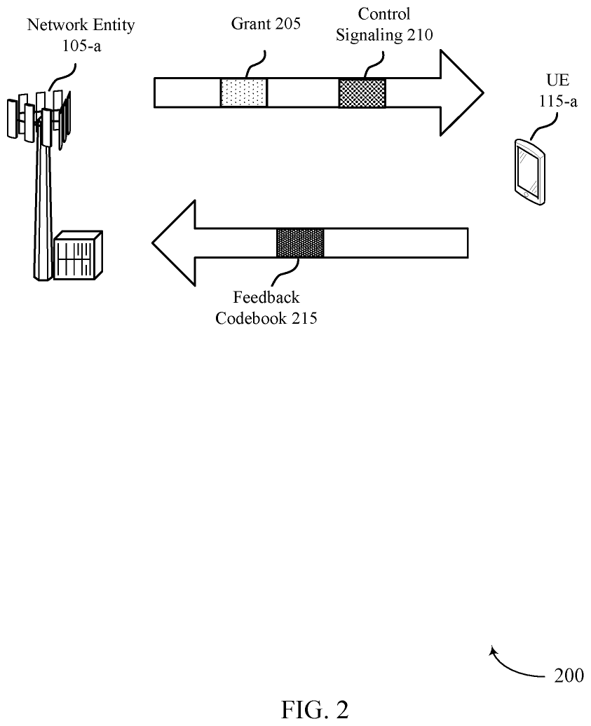

FIG. 2 shows an example of a wireless communications system 200 that supports segment based feedback codebooks in accordance with one or more aspects of the present disclosure. The wireless communications system 200 may implement, or be implemented by, aspects of the wireless communications system 100. For example, the wireless communications system 200 may include a network entity 105-a and a UE 115-a.

The wireless communications system 200 may support feedback mechanisms to indicate successful or unsuccessful reception of signaling. For example, a UE 115-a may report feedback information for a segment of resources to a network entity 105-a. More specifically, a UE 115-a may generate and transmit a feedback codebook 215 containing feedback information for a plurality of segments.

In some cases, a network entity 105-a may transmit one or more grants 205 to the UE 115-a. For example, a grant 205 may schedule one or more messages (e.g., PDSCHs) in a segment of resources. Additionally, a network entity 105-a may transmit a control signaling 210 (e.g., DCI) to a UE 115-a. For instance, the UE 115-a may receive the control signaling 210 to report feedback information for one or more segments (e.g., a segment of time and/or frequency resources). Each segment may be associated with one bit of feedback information. That is, an ACK bit or a NACK bit of a HARQ feedback may correspond to each segment. The UE 115-a may generate a feedback codebook (e.g., HARQ codebook) associated with the segments and may transmit the feedback codebook to the network entity 105-a.

A segment may include any quantity or combination of resources. For instance, a segment may be a single slot, multiple slots, (e.g., 4 slots), or a portion of a slot (e.g., a sub-slot). Additionally, a segment may be a different size and/or non-uniform in length when compared to other segments. For instance, a first segment may be a different size than a second segment.

In some cases, the resources that comprise a segment may be absolute (e.g., defined by a slot index and/or a symbol index). In other cases, the resources that comprise the segment may be relative with respect to a PUCCH transmission occasion. For instance, the segment may be a quantity of slots and/or symbols before a first PUCCH symbol. Additionally, the resources that comprise the segment may be associated with a time domain, as well as a frequency domain. For example, a time domain segment may be applied to multiple CCs in the case of CA.

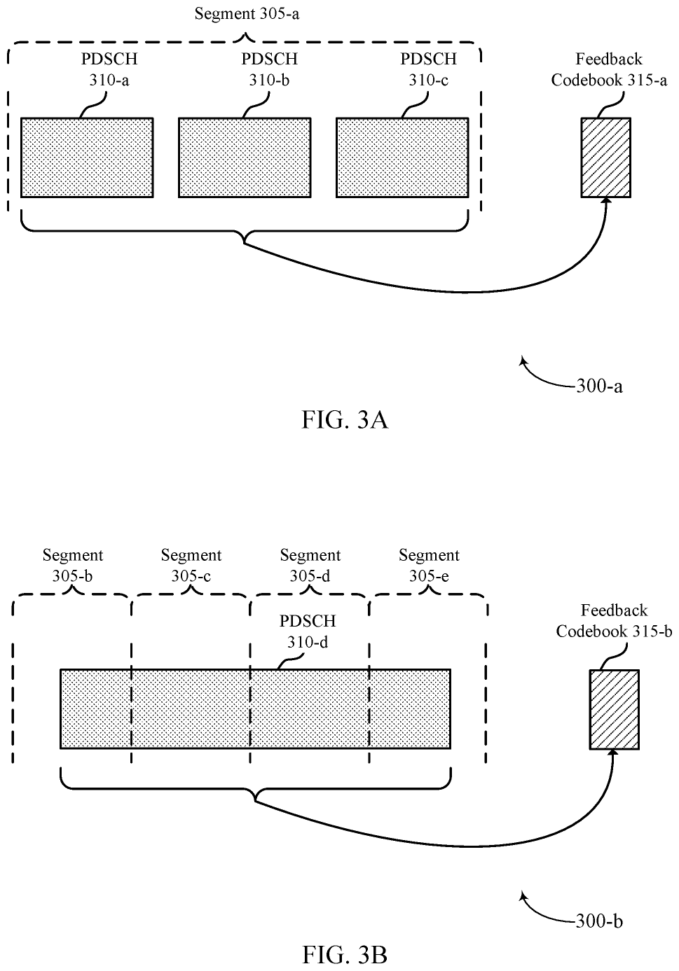

FIGS. 3A and 3B illustrate examples of grids 300-a and 300-b that supports a segment based feedback codebook in accordance with one or more aspects of the present disclosure. The grids 300-a and 300-b may implement, or be implemented by, aspects of the wireless communications system 100, the wireless communications system 200, or any combination thereof. Although the grids 300-a and 300-b are illustrated as including a certain quantity of segments 305 and PDSCHs 310, any quantity and combination of segments 305 and/or PDSCHs 310 are possible.

In some cases, a UE may report feedback information for a segment of resources (e.g., a segment 305-a). For instance, the UE may generate a feedback codebook 315 associated with one or more segments 305, and the UE may transmit the feedback codebook 315 to a network entity. In the example of the grid 300-a, a network entity may schedule multiple PDSCHs 310 (e.g., a PDSCH 310-a, a PDSCH 310-b, a PDSCH 310-c, etc.) within the segment 305-a. Additionally, or alternatively, the segment 305-a may include multiple code blocks (e.g., CBs) of PDSCHs 310. If there are multiple PDSCHs 310 within a single segment 305, the UE may bundle multiple feedback bits (e.g., an ACK or NACK bit corresponds to each PDSCH 310) together, and transmit one bit (e.g., one bit representing the bundled feedback bits).

In some cases, a network entity may schedule multiple PDSCHs 310 in the segment 305-a (e.g., the same segment). The UE may bundle all of feedback information associated with the PDSCHs 310 located within the segment 305-a and transmit a single feedback bit (e.g., in a feedback codebook 315-a) for the segment 305-a. If the UE successfully receives and decodes downlink signaling via each of the PDSCHs 310 scheduled in the segment 305-a (e.g., if each feedback bit corresponding to a PDSCH 310 in the segment 305-a is an ACK bit), then the UE may transmit a single ACK feedback bit for the segment 305-a in the feedback codebook 315-a. However, if the UE generates even one NACK bit for the segment 305-a (e.g., does not successfully receive downlink signaling via at least one of the PDSCHs 310 in the segment 305-a), the UE may transmit a single NACK bit for the segment 305-a in the feedback codebook 315-a. Feedback bundling may reduce codebook size for feedback signaling, resulting in decreased signaling overhead and more efficient use of available system resources.

In the example of the grid 300-b, a network entity may schedule a single PDSCH 310 (e.g., a PDSCH 310-d) which may span across multiple segments 305 (e.g., a segment 305-b, a segment 305-c, a segment 305-d, a segment 305-e, etc.). Additionally, or alternatively, the multiple segments 305 may include a single CB of PDSCHs 310. If the resources corresponding to a single PDSCH 310 span across more than one segment 305, the UE may generate multiple feedback bits for the single PDSCH 310, and transmit the multiple feedback bits (e.g., each bit representing a different segment 305). Such conditions may occur because each feedback bit in a feedback codebook relates to a segment (instead of relating to a message-such as a PDSCH).

For example, a network entity may schedule a single PDSCH 310-d across multiple segments 305 (e.g., the segment 305-b, the segment 305-c, the segment 305-d, the segment 305-e). The UE may generate a feedback bit for each of the segments 305 and include (e.g., transmit) each of the feedback bits in a feedback codebook 315-b. If the UE successfully receives and decodes downlink signaling via the PDSCH 310-d in each of the segments 305 (e.g., if the feedback bit corresponding to the PDSCH 310 in the segment 305-a is an ACK bit), then the UE may transmit 4 ACK feedback bits in the feedback codebook 315-b. However, if the UE generates a NACK bit for the PDSCH 310-d (e.g., does not successfully receive downlink signaling via the PDSCH 310-d the UE may transmit a NACK bit for each of the segments 305 overlapping with the PDSCH 310-d in the feedback codebook 315-b. That is, the UE may transmit 4 NACK feedback bits representing the PDSCH 310-d in the feedback codebook 315-b.

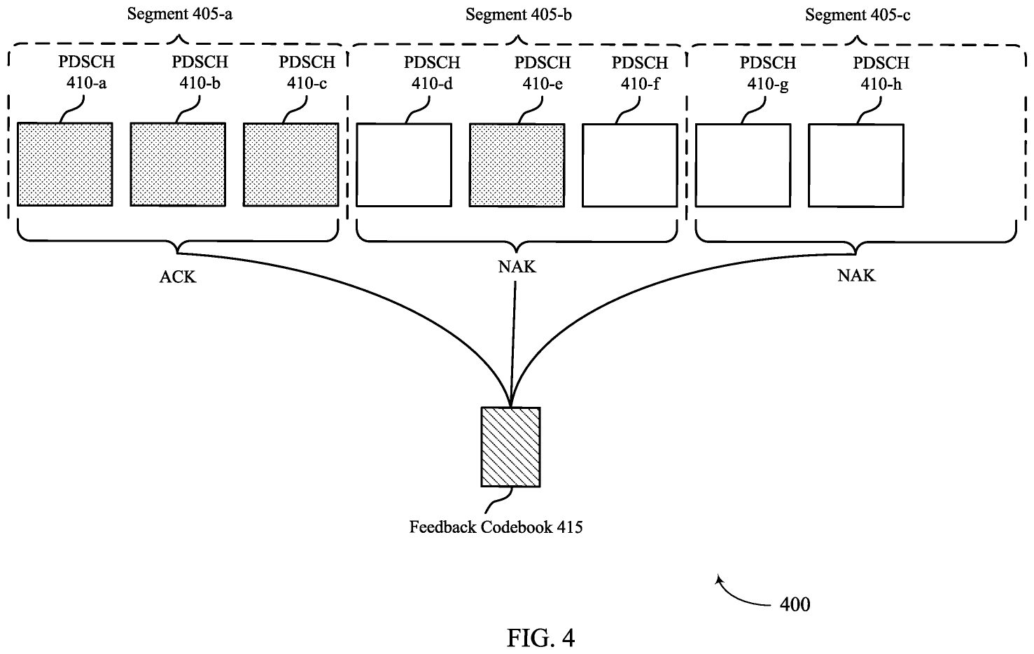

FIG. 4 shows an example of a grid 400 that supports segment based feedback codebook in accordance with one or more aspects of the present disclosure. The grid 400 may implement, or be implemented by, aspects of the wireless communications system 100, the wireless communications system 200, the grids 300-a and 300-b, or any combination thereof. Although the grid 400 is illustrated as including a certain quantity of segments 405 and PDSCHs 410, any quantity and combination of segments 405 and/or PDSCHs 410 are possible.

In some cases, the feedback codebook 415 may be a semi-static segment based codebook. Additionally, or alternatively, the feedback codebook 415 may be an example of a Type 1 codebook (e.g., legacy codebook). A UE may generate a single feedback bit for each of the PDSCH 410 candidate positions, regardless of whether a PDSCH 410 was successfully received or not. However, a feedback codebook 415 that includes a feedback bit for each of the PDSCH 410 scheduling locations may use a large quantity of resources (e.g., have a large size), resulting in significant signaling overhead.

Instead, the feedback codebook 415 may include a feedback bit for each segment 405. For example, a network entity may transmit DCI (e.g., a grant) scheduling one or more PDSCHs 410 over one or more segments 405. A UE may report feedback information for each segment of resources (e.g., a segment 405-a, a segment 405-b, a segment 405-c, etc.). For instance, the UE may generate a single feedback bit (e.g., an ACK or NACK bit) for each segment 405. The UE may generate a feedback codebook 415 including the feedback bits for each of the segments 405, and the UE may transmit the feedback codebook 415 to a network entity. That is, the feedback codebook 415 may include a single feedback bit representing each segment (e.g., the segment 405-a, the segment 405-b, and the segment 405-c).

In some cases, a Type 1 codebook may use a K0 and/or a K1 value to find out (e.g., determine) possible PDSCH 410 scheduling locations (e.g., candidate positions) corresponding to a PUCCH. In some instances the subcarrier spacing between a PDSCH 410 and a physical downlink control channel (PDCCH) may be different or the same. If the subcarrier spacing of a PDSCH 410 and the PDCCH is the same, the time delay between a DCI slot a PDSCH 410 slot may be the K0 value. That is, the K0 value may be the time delay between a DCI slot and a PDSCH 410 slot. A K1 value may indicate the time delay between a PDSCH 410 slot and an uplink control information (UCI) slot. The UCI slot may include a PUCCH carrying feedback information (e.g., an ACK or NACK bit) associated with the PDSCHs 410. In other words, the K1 value may define the time gap between a PDSCH 410 transmission and the reception of the PUCCH that carries the feedback information for the PDSCH 410.

In some cases, a UE may determine a quantity of messages (e.g., PDSCHs 410) scheduled within a segment 405 (e.g., scheduled for the resources associated with a segment 405). Further, the UE may use the K1 value (e.g., a time offset between when the PDSCHs 410 are received and a PUCCH reporting occasion to transmit the feedback information associated with the feedback codebook 415) to determine a quantity of PDSCHs 410 scheduled within the segment 405. For instance, the UE may determine which segments 405 of a set of segments (e.g., a segment 405-a, a segment 405-b, a segment 405-c, etc.) may contain one or more PDSCHs 410 scheduled to report feedback information in a target PUCCH occasion. In some instances, the UE may use multiple K1 configurations.

In some cases, a UE may generate a feedback bit (e.g., an ACK or NACK bit) for each segment 405. If there are multiple PDSCH 410 candidate positions within a segment 405, the UE may bundle the feedback information for all of the PDSCHs 410 within the segment 405 in a single feedback bit. The UE may then generate a feedback codebook 415 and transmit the feedback codebook including the single feedback bit.

In some cases, a UE may transmit an ACK bit if each of the PDSCHs 410 (e.g., quantity of messages) within a segment 405 are successfully received and decoded. For instance, a UE may determine that a segment 405-a includes three PDSCH 410 scheduling occasions. The UE may successfully decode a PDSCH 410-a, a PDSCH 410-b, and a PDSCH 410-c. Thus, the UE may include an ACK bit in the feedback codebook 415 to represent the feedback information associated with the segment 405-a.

In some cases, a UE may transmit a NACK bit if the UE fails to successfully decode (e.g., does not receive) at least one of the PDSCHs 410 (e.g., at least one of the quantity of messages) during a segment 405. For instance, a UE may determine that a segment 405-b includes three PDSCH 410 scheduling occasions. The UE may successfully decode a PDSCH 410-e, but may not successfully decode a PDSCH 410-d and/or a PDSCH 410-f. In these cases, the UE may include a NACK bit in the feedback codebook 415 to represent the feedback information associated with the segment 405-b. Additionally, the UE may determine that a segment 405-c includes two or three PDSCH 410 scheduling occasions. Alternatively, the UE may not know how many PDSCH 410 scheduling occasions are within the segment 405-c. The UE may not successfully decode a PDSCH 410-g and/or a PDSCH 410-h. Thus, the UE may include a NACK bit in the feedback codebook 415 to represent the feedback information associated with the segment 405-c.

In some cases, the feedback codebook 415 may include feedback information for multiple segments. For the example of the grid 400, the feedback codebook 415 may be a 3-bit codebook (e.g., an ACK bit for the segment 405-a, a NACK bit for the segment 405-b, and a NACK bit for the segment 405-c).

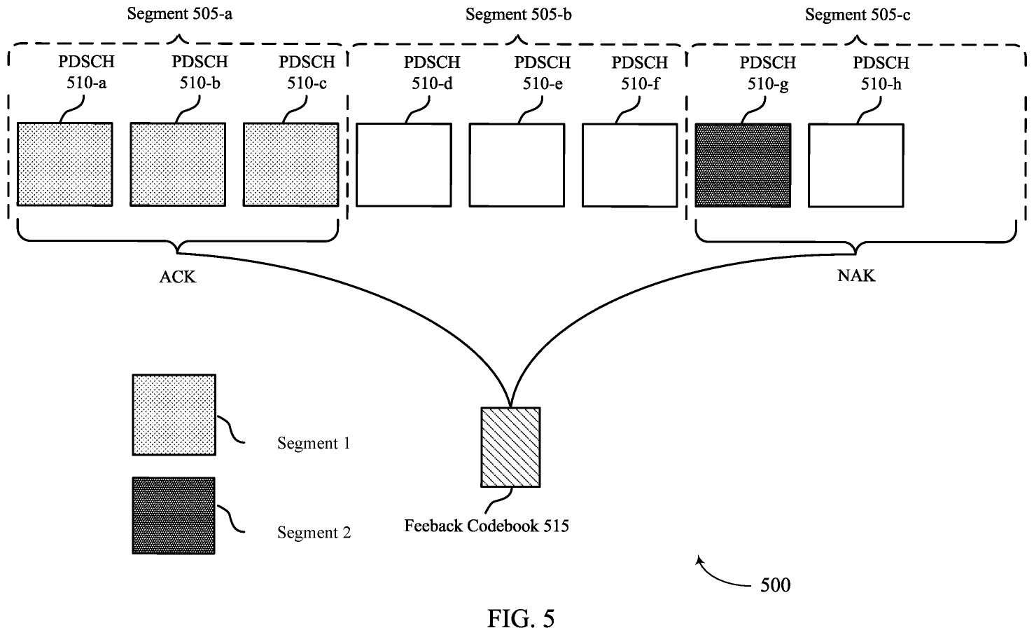

FIG. 5 shows an example of a grid 500 that supports segment based feedback codebooks in accordance with one or more aspects of the present disclosure. The grid 500 may implement, or be implemented by, aspects of the wireless communications system 100, the wireless communications system 200, the grids 300-a, 300-b, and 400, or any combination thereof. Although the grid 500 is illustrated as including a certain quantity of segments 505 and PDSCHs 510, any quantity and combination of segments 505 and/or PDSCHs 510 are possible.

In some cases, a feedback codebook 515 may be a dynamic based codebook (e.g., codebook with a dynamic length). The feedback codebook 515 may include feedback information for multiple segments 505. However, at least one of the segments 505 may not have feedback information (e.g., a corresponding ACK or NACK bit). For example, a segment 505-b may be empty (e.g., a PDSCH 510-d scheduling occasion, a PDSCH 510-e scheduling occasion, and a PDSCH 510-f scheduling occasion do not have corresponding scheduled messages). In these cases, the UE may not assign a feedback bit (e.g., no corresponding ACK or NACK bit) for the segment 505-b, decreasing the size (e.g., quantity of bits) of the feedback codebook 515.

In some cases, the UE may determine which segments 505 have relevant feedback information. For example, DCI (e.g., a grant) may indicate which one or more segments 505 have corresponding feedback information. However, a UE may fail to successfully receive DCI (e.g., due to a DCI miss detection event).

In some cases, the UE may receive one or more DCI grants scheduling one or more PDSCHs 510 during a segment 505. The DCI grants may include a segment assignment index-sometimes the segment assignment index. In some cases, the segment assignment index may be an example of a DAI. A DAI may be a type of index that relates the scheduled messages (e.g. PDSCHs) with the one HARQ ACK/NACK transmission associated with the scheduled messages. In cases where a DAI is used as the segment assignment index, a DCI may include a DAI for each PDSCH 510 transmitted in a particular segment. In other cases, where the segment assignment index is related to the segment, each PDSCH 510 transmitted in a particular segment includes the segment assignment index associated with the segment. In some examples, a DAI and a segment assignment index are synonymous and may be treated similarly. These segment index indicators may increase consecutively (e.g., 0, 1, 2, 3, etc.) from one PDSCH 510 to the next. For example, the UE may receive a first grant scheduling a PDSCH 510-a during a segment 505-a. The first grant may also include a first segment index indicator (e.g., a value of 0) associated with the segment 505-a. The UE may receive a second grant scheduling a PDSCH 510-b during the segment 505-a. The second grant may include a second segment index indicator (e.g., a value of 1) associated with the segment 505-a. The UE may receive a third grant scheduling a PDSCH 510-c during the segment 505-a. The third grant may include a third segment index indicator (e.g., a value of 2) associated with the segment 505-a. In some instances, the UE may successfully decode the PDSCH 510-a, the PDSCH 510-b, and the PDSCH 510-c. Because each PDSCH 510 within the segment 505-a was associated with an incrementally increasing (e.g., no value was skipped) segment index indicator (e.g., segment DAI), the UE may generate an ACK bit for the segment 505-a.

In some cases, a UE may determine that at least one or more segment index indicator values were skipped (e.g., there is a discontinuity of values of the segment DAI indicators received as part of the grants). Thus, the UE may generate (e.g., assign) a NACK bit to the segment 505 associated with the skipped segment index indicator. For example, a grant may schedule a PDSCH 510-g during a segment 505-c. This grant may also include a segment index indicator associated with the segment 505-c. If the segment index indicator associated with the PDSCH 510-g does not incrementally increase (e.g., increase by one) from the previous segment index indicator (e.g., if the segment index indicator associated with PDSCH 510-g is not 4), the UE may determine that it failed to detect one or more grants scheduling a PDSCH 510. Thus, the UE may generate a NACK bit for the segment 505-c in the case of a missing segment DAI value (e.g., regardless if the UE successfully decodes the PDSCH 510-g and/or a PDSCH 510-h).

In some cases, the UE may receive one or more DCI grants scheduling one or more PDSCHs 510 during one or more segments 505. The DCI grants may indicate feedback information for PDSCHs 510 to be reported in a same PUCCH occasion. Additionally, the DCI grants may include a segment index indicator. For each of the PDSCHs 510 reported in the same PUCCH occasion, an associated segment index indicator may increase for each subsequent segment 505. For example, each of the PDSCHs 510 scheduled in the segment 505-a may have a segment index of one (e.g., a value of 1). That is, the one or more grants scheduling the PDSCH 510-a, the PDSCH 510-b, and the PDSCH 510-c may include a segment index indicator (e.g., with a value of 1) associated with the segment 505-a. Similarly, each of the PDSCHs 510 scheduled in the segment 505-c may have a segment index of two (e.g., a value of 2). That is, the grant scheduling the PDSCH 510-g may include a segment index indicator (e.g., with a value of 2) associated with the segment 505-c.

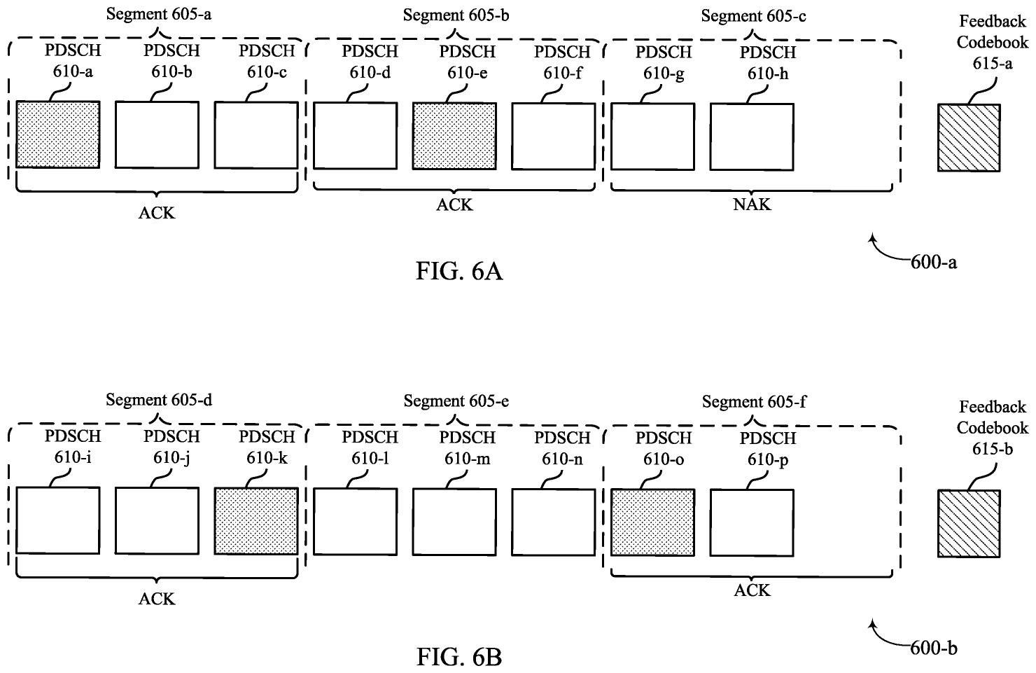

FIGS. 6A and 6B illustrate examples of grids 600-a and 600-b that support segment based feedback codebooks in accordance with one or more aspects of the present disclosure. The grids 600-a and 600-b may implement, or be implemented by, aspects of the wireless communications system 100, the wireless communications system 200, the grids 300-a through 500, or any combination thereof. Although the grids 600-a and 600-b are illustrated as including a certain quantity of segments 605 and PDSCHs 610, any quantity and combination of segments 605 and/or PDSCHs 610 are possible.

In some cases, a feedback codebook 615 may include one or more NACK to ACK (e.g., ACK to NACK) bit errors as a result of bundling. For example, a network entity may schedule multiple PDSCHs 610 (e.g., in time division multiplexing (TDM)) within a single segment 605. In some instances, a UE may detect a subset (e.g., not all) of the PDSCHs 610 scheduled for that particular segment 605. Thus, the UE may assume that it has failed to receive one or more DCI grants (e.g., a missing grant event occurred) and include a NACK bit for the missing one or more PDSCHs 610. Therefore, the feedback bit associated with the particular segment 605 may be a NACK bit. However, the UE may not be able to identify the error cases leading to automatically generating a NACK (e.g., a dummy NACK).

In some cases, the UE may identify an error case and reduce the ACK to NACK error from bundling. The UE may leverage one or more scheduling restrictions when identifying an error case. For example, the UE may implement an intra-segment bundling check.

In some cases, a UE may determine if there are any PDSCHs 610 that are scheduled but not detected (e.g., a DCI missing event) through an intra-segment bundling check. That is, the UE may determine whether a scheduled PDSCH 610 was not successfully detected. In one example, the UE may check a SLIV table. For instance, the UE may determine a start and/or a length parameter for a PDSCH 610. The UE may check multiple (e.g., all of the) possible SLIV combinations in a Time Domain Resource Allocation (TDRA) table. The UE may then compare the TDRA table with the SLIV of the detected PDSCHs 610. In a second example, the UE may perform a DCI based intra-segment bundling check. For instance, a network entity may configure a UE to expect up to a quantity of downlink grants per segment 605. That is, if a UE detects that the quantity of grants received for the resources that comprise a particular segment 605 satisfies a threshold (e.g., a preconfigured threshold of grants), the UE may determine that no other PDSCHs 610 are scheduled for that segment (e.g., because the network entity may not transmit an additional DCI grant to schedule other PDSCHs 610 in the same segment 605). In some instances, the UE may receive an indication of a maximum quantity of grants that may schedule a PDSCH 610 for a segment 605. The maximum quantity of DCIs (e.g., grants) that may grant one or more PDSCH(s) 610 in a segment may be a UE capability (e.g., indicated by the UE) or a RRC configuration.

In some cases, a network entity may transmit more than one grant scheduling PDSCHs 610 in a particular segment 605. However, if a UE receives a single DCI grant, the UE may fail to determine whether a network entity transmitted any additional DCI grants (e.g., there is a missing grant) or if only a single DCI grant was transmitted for that particular segment 605. Thus, the UE may assume that it failed to detect at least one DCI grant and generate a NACK bit (e.g., a dummy NACK bit). However, if a UE bundles feedback information for a segment 605 that includes a dummy NACK bit, the UE may unnecessarily transmit a NACK bit in a feedback codebook 615. Instead, a UE may use a SLIV for a detected grant in order to determine if there are any additional potential grants that may schedule a PDSCH 610 in the segment 605.

In some cases, a network entity may configure (e.g., transmit control signaling) a UE with a maximum quantity of PDSCHs 610 (e.g., messages) that may be scheduled (e.g., communicated via a set of resources) for a segment 605. The maximum quantity of PDSCHs 610 that may be scheduled within one segment 605 (e.g., the maximum quantity of PDSCHs 610 that the UE can support) may be a UE capability (e.g., indicated by the UE) or an RRC configuration. Thus, the UE may generate less (e.g., none) dummy NACKs. In some instances, a network entity may indicate that there is a single PDSCH 610 scheduled during a segment 605 (e.g., a UE expects low density service). In these instances, a UE may not bundle feedback information.

In the example of FIG. 6A, the network entity may configure the UE to receive one grant DCI per each segment 605. For instance, the UE may receive a grant scheduling a PDSCH 610-a during a segment 605-a. Thus, the UE may determine that the PDSCH 610-a is the only PDSCH 610 scheduled during the segment 605-a. That is, the UE may not expect that a grant was supposed to schedule a PDSCH 610-b or a PDSCH 610-c (e.g., generate a dummy NACK bit). The UE may successfully decode the PDSCH 610-a and transmit an ACK bit (e.g., in a feedback codebook 615-a) to represent the feedback information associated with the segment 605-a. Similarly, the UE may receive a grant scheduling a PDSCH 610-e during a segment 605-b. Thus, the UE may determine that the PDSCH 610-e is the only PDSCH 610 scheduled during the segment 605-b. That is, the UE may not expect that a grant was supposed to schedule a PDSCH 610-d or a PDSCH 610-f. The UE may successfully decode the PDSCH 610-e and transmit an ACK bit (e.g., in a feedback codebook 615-a) to represent the feedback information associated with the segment 605-b. The feedback codebook 615-a may represent a semi-static codebook. Thus, if the UE fails to decode a PDSCH 610-g and/or a PDSCH 610-h during a segment 605-c, the UE may generate a NACK bit to represent the feedback information associated with the segment 605-c. In some instances, the feedback codebook 615-a may be a 3-bit codebook (e.g., the codebook 615-a includes an ACK bit to represent the feedback information from the segment 605-a, an ACK bit to represent the feedback information from the segment 605-b, and a NACK bit to represent the feedback information from the segment 605-c).

In the example of FIG. 6B, the network entity may configure the UE to receive one grant DCI per each segment 605. For instance, the UE may receive a grant scheduling a PDSCH 610-k during a segment 605-d. Thus, the UE may determine that the PDSCH 610-k is the only PDSCH 610 scheduled during the segment 605-d. That is, the UE may not expect that a grant was supposed to schedule a PDSCH 610-i or a PDSCH 610-j (e.g., and generate a dummy NACK bit). The UE may successfully decode the PDSCH 610-k and transmit an ACK bit (e.g., in a feedback codebook 615-b) to represent the feedback information associated with the segment 605-d. Similarly, the UE may receive a grant scheduling a PDSCH 610-o during a segment 605-f. Thus, the UE may determine that the PDSCH 610-o is the only PDSCH 610 scheduled during the segment 605-f. That is, the UE may not expect that a grant was supposed to schedule a PDSCH 610-p. The UE may successfully decode the PDSCH 610-o and transmit an ACK bit (e.g., in a feedback codebook 615-b) to represent the feedback information associated with the segment 605-f. The feedback codebook 615-b may represent a dynamic codebook. Thus, a segment 605-e may be empty and a UE may not generate a NACK bit if the UE fails to decode a PDSCH 610-1, a PDSCH 610-m, and/or a PDSCH 610-n during a segment 605-c. In some instances, the feedback codebook 615-b may be a 2-bit codebook (e.g., the codebook 615-b includes an ACK bit to represent the feedback information from the segment 605-d and an ACK bit to represent the feedback information from the segment 605-f).

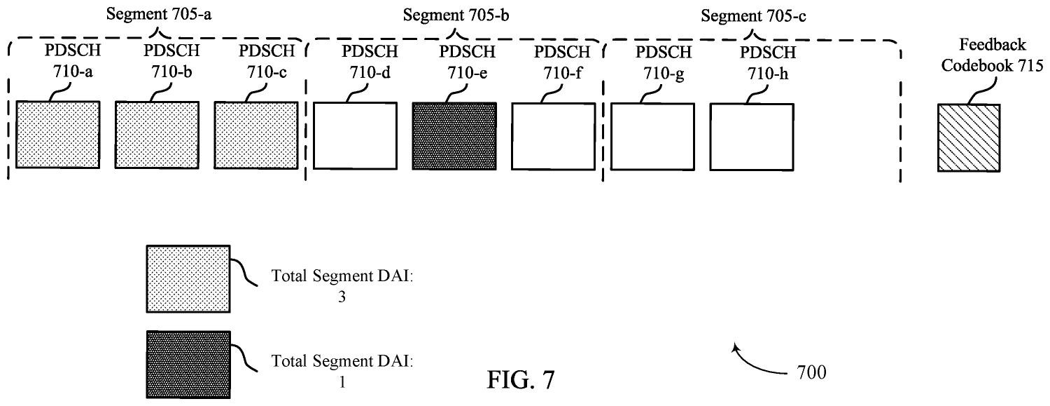

FIG. 7 shows an example of a grid 700 that supports segment based feedback codebooks in accordance with one or more aspects of the present disclosure. The grid 700 may implement, or be implemented by, aspects of the wireless communications system 100, the wireless communications system 200, the grids 300-a through 600-b, or any combination thereof. Although the grid 700 is illustrated as including a certain quantity of segments 705 and PDSCHs 710, any quantity and combination of segments 705 and/or PDSCHs 710 are possible.

In some cases, a network entity may transmit more than one grant capable of scheduling PDSCHs 710 per segment 705. However, if a UE receives a single DCI grant, the UE may fail to determine whether a network entity transmitted any additional DCI grants (e.g., there is a missing grant) or if a single DCI grant was transmitted for that particular segment 705. For instance, a UE may determine that the segment limit (e.g., a maximum quantity of grants capable of scheduling PDSCHs 710 per segment 705) is two. Further, the UE may detect a single grant. Thus, the UE may not be able to distinguish between failing to detect a second grant or only one grant being scheduled and transmitted during the segment. In these cases, the UE may assume that it failed to detect at least one DCI grant and generate a NACK bit (e.g., a dummy NACK bit). However, if a UE bundles feedback information for a segment 705 that includes a dummy NACK bit, the UE may unnecessarily transmit a NACK bit in a feedback codebook 715. Instead, a UE may perform intra-segment missing grant detection in order to determine if there are any undetected potential grants that may schedule a PDSCH 710 in a segment 705.

In some cases, a UE may receive one or more DCI grants scheduling one or more PDSCHs 710 during a segment 705. The DCI grants may include a total segment DAI (e.g., a message quantity indicator). Additionally, or alternatively, the DCI grants may include a segment index indicator, as described with reference to FIG. 5. The message quantity indicator may indicate a quantity of PDSCHs 710 that may be scheduled (e.g., communicated via resources) within a segment 705. Each grant scheduling a PDSCH 710 within the same segment 705 may include the message quantity indicator (e.g., total segment DAI value). For instance, a UE may receive one or more grants scheduling a PDSCH 710-a, a PDSCH 710-b, and a PDSCH 710-c within a segment 705-a. The one or more grants may indicate that the message quantity indicator associated with the segment 705-a is three (e.g., a value of 3). Thus, if the UE successfully decodes the PDSCH 710-a, the PDSCH 710-b, and the PDSCH 710-c (e.g., the UE decodes three total messages in the segment 705-a), the UE may generate an ACK bit representing the feedback information associated with the segment 705-a. Similarly, the UE may receive a grant scheduling a PDSCH 710-e within a segment 705-b. This grant may indicate that a message quantity indicator associated with the segment 705-b is one (e.g., a value of 1). In this case, the UE may determine that there is only one PDSCH 710 scheduled in the segment 705-b and may not expect to receive a PDSCH 710-d or a PDSCH 710-f. Thus, if the UE successfully decodes the PDSCH 710-e, the UE may generate an ACK bit representing the feedback information associated with the segment 705-b.

In some cases, the feedback codebook 715 may represent a semi-static codebook. Thus, if the UE fails to decode a PDSCH 710-g and/or a PDSCH 710-h during a segment 705-c, the UE may generate a NACK bit to represent the feedback information associated with the segment 705-c. In some instances, the feedback codebook 715 may be a 3-bit codebook (e.g., the codebook 715 includes an ACK bit to represent the feedback information from the segment 705-a, an ACK bit to represent the feedback information from the segment 705-b, and a NACK bit to represent the feedback information from the segment 705-c). In some other cases, the feedback codebook 715 may represent a dynamic codebook. Thus, a segment 705-c may be empty and a UE may not generate a NACK bit if the UE fails to decode a PDSCH 710-g and/or a PDSCH 710-h during a segment 705-c. In some instances, the feedback codebook 715 may be a 2-bit codebook (e.g., the codebook 715 includes an ACK bit to represent the feedback information from the segment 705-a and an ACK bit to represent the feedback information from the segment 705-b).

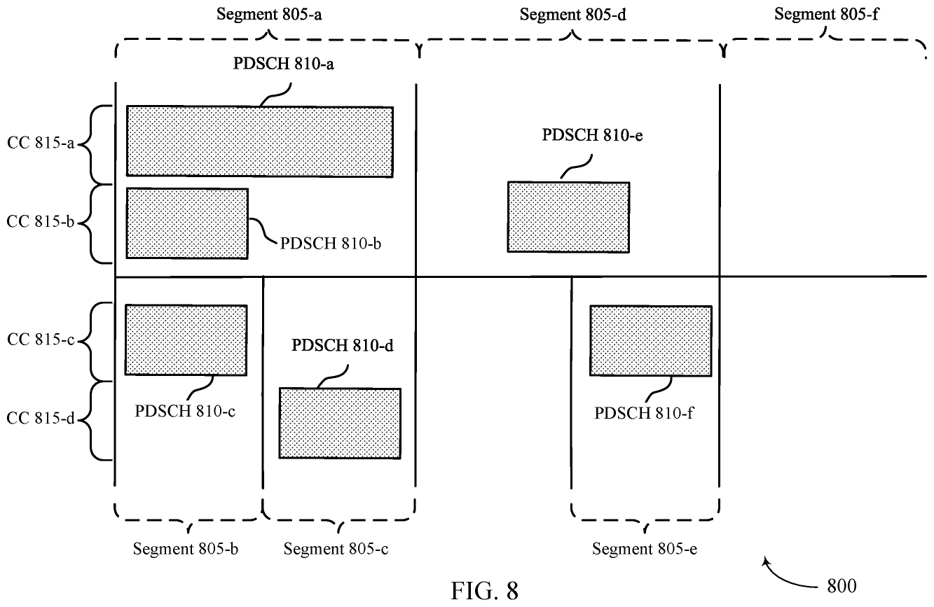

FIG. 8 shows an example of a grid 800 that supports segment based feedback codebooks in accordance with one or more aspects of the present disclosure. The grid 800 may implement, or be implemented by, aspects of the wireless communications system 100, the wireless communications system 200, the grids 300-a through 700, or any combination thereof. Although the grid 800 is illustrated as including a certain quantity of segments 805, PDSCHs 810, and CCs 815, any quantity and combination of segments 805, PDSCHs 810, and CCs 815 are possible.

In some cases, a UE may generate a feedback codebook including feedback information from PDSCHs 810 scheduled for different segments 805 and/or different CCs 815. That is, a segment of resources may be defined over time domain resources and one or more CCs 815. In some instances, one or more segments 805 may be defined in a time domain. That is, the same segment boundaries may apply to each of the CCs 815.

In some cases, a network entity may configure a UE with a per segment limitation of 1 (e.g., a maximum of one DCI grant scheduling one or more PDSCHs 810 per segment 805). However, the throughput in these cases may be relatively low. Alternatively, a network entity may configure a UE to utilize a CA mode for improved scheduling flexibility. For instance, the network entity may serve a UE from any quantity of CCs (e.g., a CC 815-a, a CC 815-b, a CC 815-c, a CC 815-d, etc.). In these instances, even if the per segment limitation is set to 1, a multi-carrier grant may schedule multiple CCs 815 to the UE at the same time (e.g., over overlapping time resources) which may be beneficial for intra band CA (e.g., multiple CCs 815 in frequency range (FR) 2). However, the same segment 805 boundary may not apply to each of the CCs 815 (e.g., for inter-band CA with different subcarrier spacing, inter-FR, etc.).

In some cases, a segment 805 may be defined in both the time domain and the frequency domain (e.g., for CA operation). For example, a time domain segment may be defined over a subset of CCs 815 (e.g., the frequency domain). In general, different time domain segments may be defined for different subsets of CCs 815. In some instances, a segment 805 boundary may be aligned or nested across different CCs 815. Additionally, or alternatively, a network entity may define a different per segment grant limit (e.g., a maximum quantity of grants scheduling PDSCHs 810 in a segment 805) for different segments 805 (e.g., across the frequency domain).

In some cases, a network entity may configure a UE may report feedback information for PDSCHs 810 across different CCs 815. For example, the UE may receive control signaling to report feedback information for a PDSCH 810-a within a segment 805-a and across a CC 815-a. Additionally, the UE may report feedback for a PDSCH 810-b within the same segment 805-a but across a CC 815-b (e.g., a different frequency). The UE may bundle the feedback information for the segment 805-a (e.g., transmit one feedback bit).

In some cases, the UE may receive additional control signaling to report feedback information for a segment 805-b. The time domain resources that comprise the segment 805-b may at least partially overlap with the time domain resources that comprise the segment 805-a. At the same time, the segment 805-b may be associated with one or more different CCs (e.g., a CC 815-c and a CC 815-d). That is, the UE may generate a single feedback bit for the PDSCHs 810 (e.g., a PDSCH 810-c) within the segment 805-b. Similarly, the UE may report feedback information for a segment 805-c (e.g., including a PDSCH 810-d).

In some cases, a UE may generate a semi-static segment based codebook. In these cases, the UE may determine a quantity of grants per segment 805 (e.g., a per segment limit), a quantity of PDSCHs 810 per grant, a quantity of PDSCHs 810 per segment 805 (e.g., for a per segment 805 missing PDSCH 810 check), or any combination thereof when generating a feedback codebook.

In some cases, a UE may generate a dynamic segment based codebook (e.g., a feedback codebook of dynamic length). For example, the UE may receive one or more DCI grants scheduling one or more PDSCHs 810 during one or more segments 805 and across one or more CCs 815. The DCI grants may indicate feedback information for PDSCHs 810 to be reported in a same PUCCH occasion. Additionally, the DCI grants may include a segment index indicator (e.g., a total DAI). For each of the PDSCHs 810 to be reported in the same PUCCH occasion, an associated segment index indicator may increase for each subsequent segment 805. For example, each of the PDSCHs 810 scheduled in the segment 805-a may have a segment index of one (e.g., a value of 1). That is, the one or more grants scheduling the PDSCH 810-a and the PDSCH 810-b may include a segment index indicator (e.g., with a value of 1) associated with the segment 805-a. Similarly, each of the PDSCHs 810 scheduled in the segment 805-b may have a segment index of two (e.g., a value of 2). That is, the grant scheduling the PDSCH 810-c may include a segment index indicator (e.g., with a value of 2) associated with the segment 805-b. The PDSCHs 810 (e.g., a PDSCH 810-d) scheduled in a segment 805-c may have a segment index of three (e.g., a value of 3).

In some cases, the UE may determine that it has failed to detect (e.g., missed) one or more grants by using the segment index indicator. For example, a UE may fail to detect a grant scheduling a PDSCH 810-e within a segment 805-d and across a CC 815-b. However, a UE may detect a grant scheduling a PDSCH 810-f within a segment 805-e and across a CC 815-c. The grant scheduling the PDSCH 810-f may include a segment index indicator of five (e.g., a value of 5) associated with the segment 805-c. Thus, the UE may determine that a segment index value is missing (e.g., a segment index value of 4 was skipped). The UE may determine that it failed to detect a grant as a result of the discontinuity of values of segment index indicators and generate a NACK representing the feedback information for the segment 805-d.

In some cases, a UE may fail to detect the grant scheduling the PDSCH 810-f within the segment 805-e. If no future grants are transmitted (e.g., no subsequent PDSCHs 810 are scheduled in a segment 805-f), the UE may fail to determine that a grant was missed leading to a mismatch in the codebook size (e.g., a mismatch between the quantity of segments 805 and the quantity of feedback bits in a codebook).

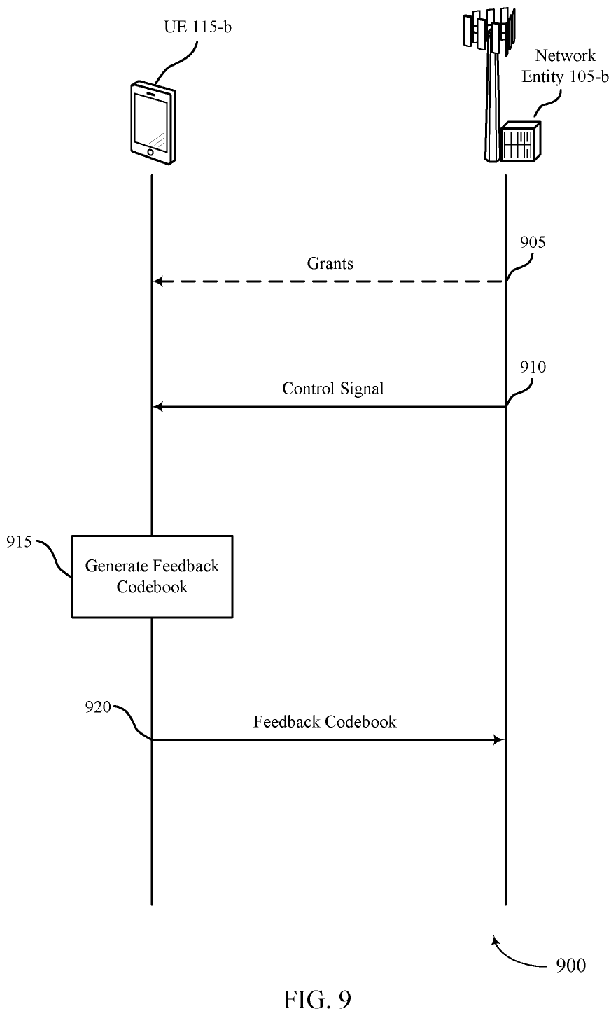

FIG. 9 shows an example of a process flow 900 that supports segment based feedback codebooks in accordance with one or more aspects of the present disclosure. The process flow 900 may implement aspects of, or be implemented by aspects of, the wireless communications system 100, the wireless communications system 200, the grids 300-a through 800, or any combination thereof. For example, the process flow 900 may include a UE 115-b and network entity 105-b, which may be examples of corresponding devices described with reference to FIG. 1 and FIG. 2.

In the following description of the process flow 900, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 900, and other operations may be added to the process flow 900.

At 905, the UE 115-b may receive (e.g., from the network entity 105-b) one or more grants scheduling one or more PDSCHs (e.g., messages) within a segment of resources. A segment may be any quantity and combination of time and/or frequency resources.

At 910, the UE may receive (e.g., from the network entity 105-b) control signaling to report feedback information for a segment of resources, as described herein. The feedback information may include an ACK bit or a NACK bit of HARQ feedback associated with the segment.

At 915, the UE may generate a feedback codebook. The feedback codebook may be associated with a PUCCH reporting occasion. Additionally, the feedback codebook may include a feedback bit corresponding to each segment associated with the PUCCH reporting occasion. The UE may bundle feedback information for multiple PDSCHs within a segment into a single feedback bit. In some instances the feedback codebook may be semi-static or dynamic.

At 920, the UE may transmit (e.g., to the network entity 105-b) the feedback codebook (e.g., the feedback codebook generated at 915). The feedback codebook may include one or more bits of HARQ feedback, as described herein.

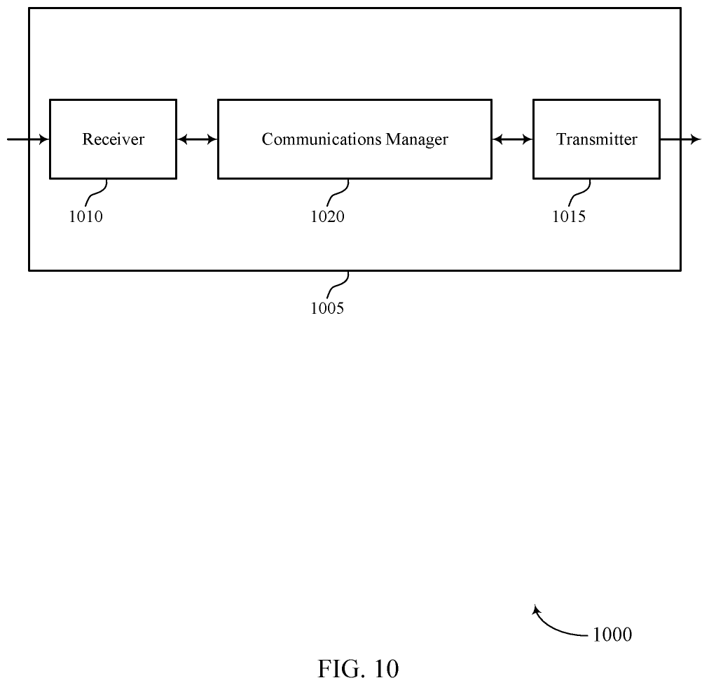

FIG. 10 shows a block diagram 1000 of a device 1005 that supports segment based feedback codebook in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (for example, control channels, data channels, information channels related to segment based feedback codebook). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (for example, control channels, data channels, information channels related to segment based feedback codebook). In some implementations, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of segment based feedback codebook as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving control signaling to report feedback information for a segment of resources, the segment being associated with one bit of the feedback information including an acknowledgment bit or a negative-acknowledgment bit of a hybrid automatic repeat request feedback. The communications manager 1020 is capable of, configured to, or operable to support a means for generating a feedback codebook associated with a set of multiple segments based on the control signaling. The communications manager 1020 is capable of, configured to, or operable to support a means for transmitting the feedback codebook for the set of multiple segments based on generating the feedback codebook, the feedback codebook including the one bit of the feedback information associated with the segment according to the feedback codebook.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more flexible and responsive communication and more efficient utilization of communication resources.

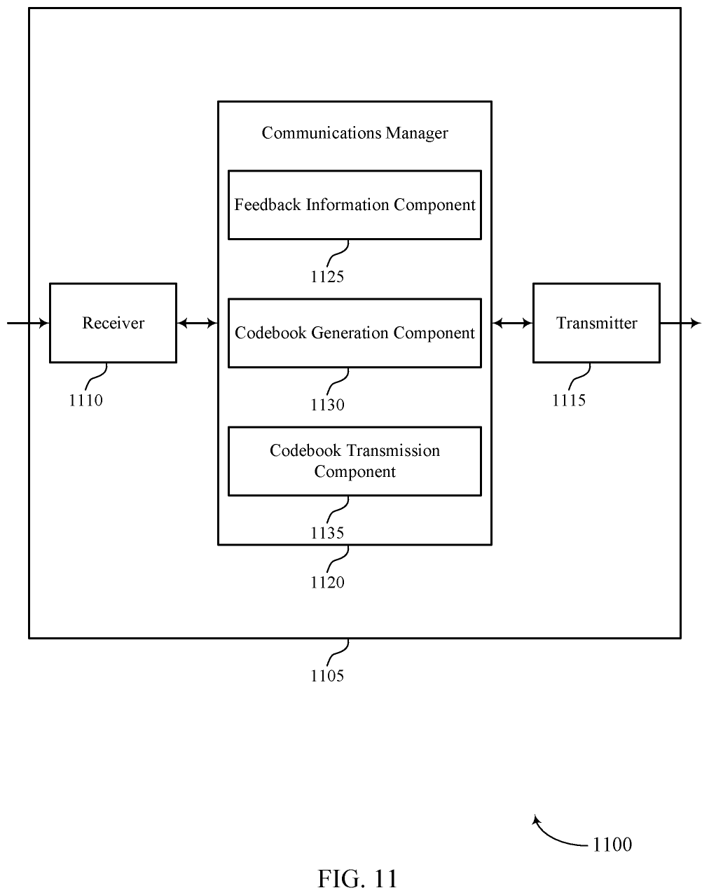

FIG. 11 shows a block diagram 1100 of a device 1105 that supports segment based feedback codebook in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one of more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (for example, control channels, data channels, information channels related to segment based feedback codebook). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (for example, control channels, data channels, information channels related to segment based feedback codebook). In some implementations, the transmitter 1115 may be co-located with a receiver 1110 in a transceiver module. The transmitter 1115 may utilize a single antenna or a set of multiple antennas.

The device 1105, or various components thereof, may be an example of means for performing various aspects of segment based feedback codebook as described herein. For example, the communications manager 1120 may include a feedback information component 1125, a codebook generation component 1130, a codebook transmission component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The feedback information component 1125 is capable of, configured to, or operable to support a means for receiving control signaling to report feedback information for a segment of resources, the segment being associated with one bit of the feedback information including an acknowledgment bit or a negative-acknowledgment bit of a hybrid automatic repeat request feedback. The codebook generation component 1130 is capable of, configured to, or operable to support a means for generating a feedback codebook associated with a set of multiple segments based on the control signaling. The codebook transmission component 1135 is capable of, configured to, or operable to support a means for transmitting the feedback codebook for the set of multiple segments based on generating the feedback codebook, the feedback codebook including the one bit of the feedback information associated with the segment according to the feedback codebook.

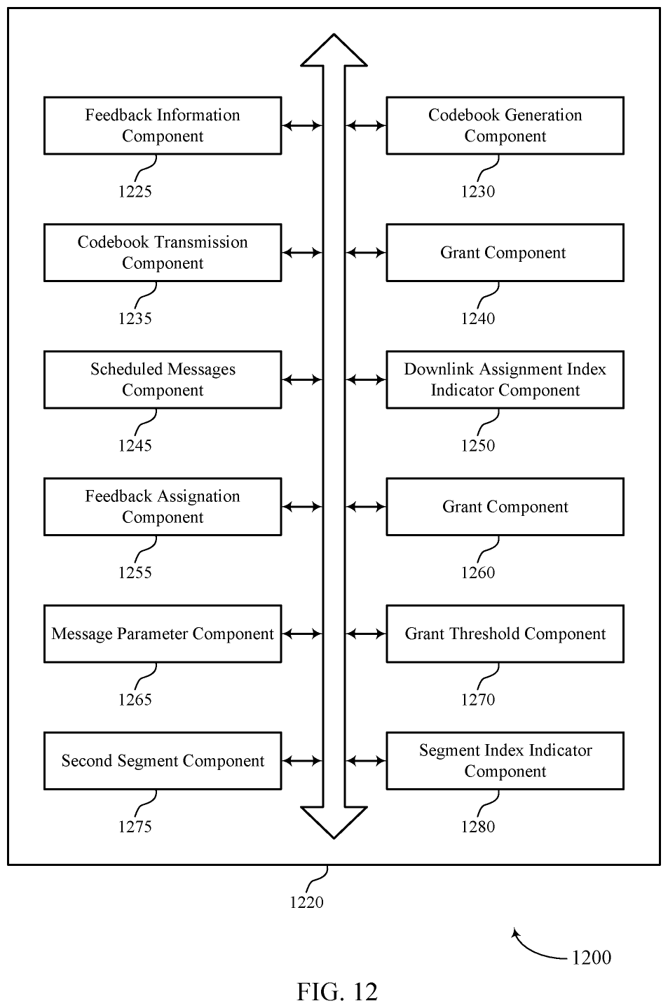

FIG. 12 shows a block diagram 1200 of a communications manager 1220 that supports segment based feedback codebook in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of segment based feedback codebook as described herein. For example, the communications manager 1220 may include a feedback information component 1225, a codebook generation component 1230, a codebook transmission component 1235, a grant component 1240, a scheduled messages component 1245, a downlink assignment index indicator component 1250, a feedback assignation component 1255, a grant component 1260, a message parameter component 1265, a grant threshold component 1270, a second segment component 1275, a segment index indicator component 1280, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The feedback information component 1225 is capable of, configured to, or operable to support a means for receiving control signaling to report feedback information for a segment of resources, the segment being associated with one bit of the feedback information including an acknowledgment bit or a negative-acknowledgment bit of a hybrid automatic repeat request feedback. The codebook generation component 1230 is capable of, configured to, or operable to support a means for generating a feedback codebook associated with a set of multiple segments based on the control signaling. The codebook transmission component 1235 is capable of, configured to, or operable to support a means for transmitting the feedback codebook for the set of multiple segments based on generating the feedback codebook, the feedback codebook including the one bit of the feedback information associated with the segment according to the feedback codebook.

In some examples, the grant component 1240 is capable of, configured to, or operable to support a means for receiving one or more grants scheduling one or more messages in the segment, where generating the feedback codebook is based on receiving the one or more grants.

In some examples, the scheduled messages component 1245 is capable of, configured to, or operable to support a means for determining a quantity of messages scheduled for the resources that include the segment based on offsets between a time when the quantity of messages are received and an uplink occasion to transmit the feedback information associated with the feedback codebook, where generating the feedback codebook is based on determining the quantity of messages.

In some examples, the one bit of the feedback information associated with the segment includes information for the quantity of the messages.

In some examples, to support transmitting the feedback codebook, the codebook transmission component 1235 is capable of, configured to, or operable to support a means for transmitting the one bit of the feedback information including the acknowledgment bit if each of the quantity of messages are successfully decoded.

In some examples, to support transmitting the feedback codebook, the codebook transmission component 1235 is capable of, configured to, or operable to support a means for transmitting the one bit of the feedback information including the negative-acknowledgment bit if at least one of the quantity of messages fails to be successfully decoded.

In some examples, to support generating the feedback codebook, the downlink assignment index indicator component 1250 is capable of, configured to, or operable to support a means for determining a discontinuity of values of downlink assignment index indicators received as part of grants. In some examples, to support generating the feedback codebook, the feedback assignation component 1255 is capable of, configured to, or operable to support a means for assigning a negative acknowledgement to the segment in the feedback codebook based on determining the discontinuity of the values.

In some examples, the grant component 1260 is capable of, configured to, or operable to support a means for receiving a grant for a first message to be communicated during the segment, the grant including a first downlink assignment index indicator associated with the segment, where generating the feedback codebook is based on the first downlink assignment index indicator.

In some examples, the grant component 1260 is capable of, configured to, or operable to support a means for receiving a second grant for a second message to be communicated during the segment, the second grant including a second downlink assignment index indicator associated with the segment and different than the first downlink assignment index indicator. In some examples, the grant component 1260 is capable of, configured to, or operable to support a means for receiving a third grant for a third message to be communicated during the segment, the third grant including a third downlink assignment index indicator associated with the segment and different than the first downlink assignment index indicator and the second downlink assignment index indicator.

In some examples, the message parameter component 1265 is capable of, configured to, or operable to support a means for determining a start parameter and a length parameter for a message scheduled to be communicated via the resources that include the segment, where generating the feedback codebook is based on determining the start parameter and the length parameter.

In some examples, the grant threshold component 1270 is capable of, configured to, or operable to support a means for determining whether a quantity of grants received for the resources that include the segment satisfies a threshold, where generating the feedback codebook is based on determining whether the quantity of grants received satisfies the threshold.

In some examples, the scheduled messages component 1245 is capable of, configured to, or operable to support a means for determining whether a message scheduled to be communicated via the resources that include the segment was not successfully detected, where generating the feedback codebook is based on determining whether the message was not successfully detected.

In some examples, the scheduled messages component 1245 is capable of, configured to, or operable to support a means for receiving second control signaling including an indication of a maximum quantity of messages capable of being scheduled to be communicated via the resources that include the segment, where generating the feedback codebook is based on receiving the second control signaling.

In some examples, the scheduled messages component 1245 is capable of, configured to, or operable to support a means for transmitting signaling to indicate a maximum quantity of messages that the UE can support being scheduled in the resources that include the segment, where receiving the second control signaling is based on transmitting the signaling.

In some examples, the scheduled messages component 1245 is capable of, configured to, or operable to support a means for receiving second control signaling including an indication of a maximum quantity of grants capable of scheduling messages to be communicated via the resources that include the segment, where generating the feedback codebook is based on receiving the second control signaling.

In some examples, to support receiving the control signaling, the grant component 1260 is capable of, configured to, or operable to support a means for receiving a grant for a first message to be communicated during the segment, the grant including a message quantity indicator associated with a quantity of messages scheduled to be communicated via the resources that include the segment, where generating the feedback codebook is based on the message quantity indicator.

In some examples, to support receiving the control signaling, the grant component 1260 is capable of, configured to, or operable to support a means for receiving a grant for a first message to be communicated during the segment, the grant including a segment index indicator associated with the segment and a message quantity indicator associated with a quantity of messages scheduled to be communicated via the resources that include the segment. In some examples, to support receiving the control signaling, the grant component 1260 is capable of, configured to, or operable to support a means for receiving a second grant for a second message to be communicated during the segment, the second grant including the segment index indicator and the message quantity indicator, where generating the feedback codebook is based on the segment index indicator and the message quantity indicator.

In some examples, the resources that include the segment are defined over time domain resources and one or more component carriers of a set of multiple component carriers.

In some examples, the second segment component 1275 is capable of, configured to, or operable to support a means for receiving second control signaling to report the feedback information for a second segment of resources, the resources that include the second segment are defined over second time domain resources that at least partially overlaps with the time domain resources and at least one component carrier different than the one or more component carriers, where generating the feedback codebook is based on the second control signaling.

In some examples, the codebook generation component 1230 is capable of, configured to, or operable to support a means for generating a feedback codebook of dynamic length, where generating the feedback codebook is based on generating the feedback codebook of dynamic length.

In some examples, to support generating the feedback codebook of dynamic length, the grant component 1260 is capable of, configured to, or operable to support a means for receiving one or more grants scheduling one or more messages in the set of multiple segments, the one or more grants including a segment index indicator. In some examples, to support generating the feedback codebook of dynamic length, the segment index indicator component 1280 is capable of, configured to, or operable to support a means for determining a discontinuity of values of segment index indicators received as part of grants. In some examples, to support generating the feedback codebook of dynamic length, the feedback assignation component 1255 is capable of, configured to, or operable to support a means for assigning a negative acknowledgement to at least one segment in the feedback codebook based on determining the discontinuity of the values.

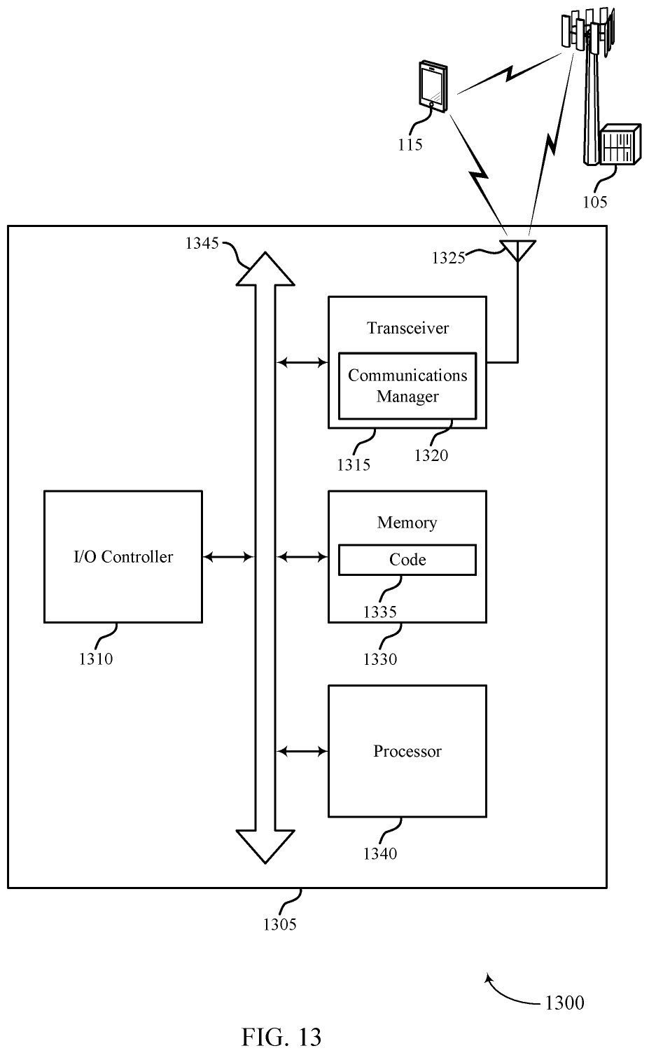

In some examples, a set of multiple messages is received via the resources that include the segment. In some examples, the segment includes one or more slots, one or more portions of a slot, or a combination thereof. In some examples, a first size of a first segment is different than a second size of a second segment. In some examples, the resources that include the segment are defined by a slot index, a symbol index, or any combination thereof. In some examples, the resources that include the segment are defined by a physical uplink control channel transmission occasion. In some examples, the resources that include the segment are associated with a time domain, a frequency domain, or any combination thereof. FIG. 13 shows a diagram of a system 1300 including a device 1305 that supports segment based feedback codebook in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 also may manage peripherals not integrated into the device 1305. In some implementations, the I/O controller 1310 may represent a physical connection or port to an external peripheral. In some implementations, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some implementations, the I/O controller 1310 may be implemented as part of a processor or processing system, such as the processor 1340. In some implementations, a user may interact with the device 1305 via the I/O controller 1310 or via hardware components controlled by the I/O controller 1310.

In some implementations, the device 1305 may include a single antenna 1325. However, in some other implementations, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 also may include a modem to modulate the packets, to provide the modulated packets to one or more antennas 1325 for transmission, and to demodulate packets received from the one or more antennas 1325. In some implementations, the transceiver 1315 may include one or more interfaces, such as one or more interfaces coupled with the one or more antennas 1325 that are configured to support various receiving or obtaining operations, or one or more interfaces coupled with the one or more antennas 1325 that are configured to support various transmitting or outputting operations, or a combination thereof. In some implementations, the transceiver 1315 may include or be configured for coupling with one or more processors or memory components that are operable to perform or support operations based on received or obtained information or signals, or to generate information or other signals for transmission or other outputting, or any combination thereof. In some implementations, the transceiver 1315, or the transceiver 1315 and the one or more antennas 1325, or the transceiver 1315 and the one or more antennas 1325 and one or more processors or memory components (for example, the processor 1340, or the memory 1330, or both), may be included in a chip or chip assembly that is installed in the device 1305.

The at least one memory 1330 may include random access memory (RAM), read-only memory (ROM), or any combination thereof. The at least one memory 1330 may store computer-readable, computer-executable code 1335 including instructions that, when executed by one or more of the at least one processor 1340, cause the device 1305 to perform various functions described herein. The code 1335 may be stored in a non-transitory computer-readable medium such as system memory or another type of memory. In some implementations, the code 1335 may not be directly executable by a processor of the at least one processor 1340 but may cause a computer (for example, when compiled and executed) to perform functions described herein. In some implementations, the at least one memory 1330 may contain, among other things, a basic I/O system (BIOS) which may control basic hardware or software operation such as the interaction with peripheral components or devices. In some implementations, the at least one processor 1340 may include multiple processors and the at least one memory 1330 may include multiple memories. One or more of the multiple processors may be coupled with one or more of the multiple memories which may, individually or collectively, be configured to perform various functions herein (for example, as part of a processing system).

The at least one processor 1340 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1340 may be configured to operate a memory array using a memory controller. In some other cases, a memory controller may be integrated into one or more of the at least one processor 1340. The at least one processor 1340 may be configured to execute computer-readable instructions stored in a memory (e.g., one or more of the at least one memory 1330) to cause the device 1305 to perform various functions (e.g., functions or tasks supporting segment based feedback codebook). For example, the device 1305 or a component of the device 1305 may include at least one processor 1340 and at least one memory 1330 coupled with one or more of the at least one processor 1340, the at least one processor 1340 and the at least one memory 1330 configured to perform various functions described herein. The at least one processor 1340 may be an example of a cloud-computing platform (e.g., one or more physical nodes and supporting software such as operating systems, virtual machines, or container instances) that may host the functions (e.g., by executing code 1335) to perform the functions of the device 1305. The at least one processor 1340 may be any one or more suitable processors capable of executing scripts or instructions of one or more software programs stored in the device 1305 (such as within one or more of the at least one memory 1330). In some implementations, the at least one processor 1340 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the at least one processor 1340, or the transceiver 1315, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

The communications manager 1320 may support wireless communications in accordance with examples as disclosed herein. For example, the communications manager 1320 is capable of, configured to, or operable to support a means for receiving control signaling to report feedback information for a segment of resources, the segment being associated with one bit of the feedback information including an acknowledgment bit or a negative-acknowledgment bit of a hybrid automatic repeat request feedback. The communications manager 1320 is capable of, configured to, or operable to support a means for generating a feedback codebook associated with a set of multiple segments based on the control signaling. The communications manager 1320 is capable of, configured to, or operable to support a means for transmitting the feedback codebook for the set of multiple segments based on generating the feedback codebook, the feedback codebook including the one bit of the feedback information associated with the segment according to the feedback codebook.

By including or configuring the communications manager 1320 in accordance with examples as described herein, the device 1305 may support techniques for improved user experience related to reduced processing, more efficient utilization of communication resources, improved coordination between devices, improved utilization of processing capability.

In some implementations, the communications manager 1320 may be configured to perform various operations (for example, receiving, monitoring, transmitting) using or otherwise in cooperation with the transceiver 1315, the one or more antennas 1325, or any combination thereof. Although the communications manager 1320 is illustrated as a component of the transceiver 1315, in some implementations, one or more functions described with reference to the communications manager 1320 may be supported by or performed by the transceiver 1315, the at least one processor 1340, the at least one memory 1330, the code 1335, or any combination thereof (for example, by a processing system including at least a portion of the at least one processor 1340, the at least one memory 1330, the code 1335, or any combination thereof). For example, the code 1335 may include instructions executable by one or more of the at least one processor 1340 to cause the device 1305 to perform various aspects of segment based feedback codebook as described herein, or the at least one processor 1340 and the at least one memory 1330 may be otherwise configured to perform or support such operations.

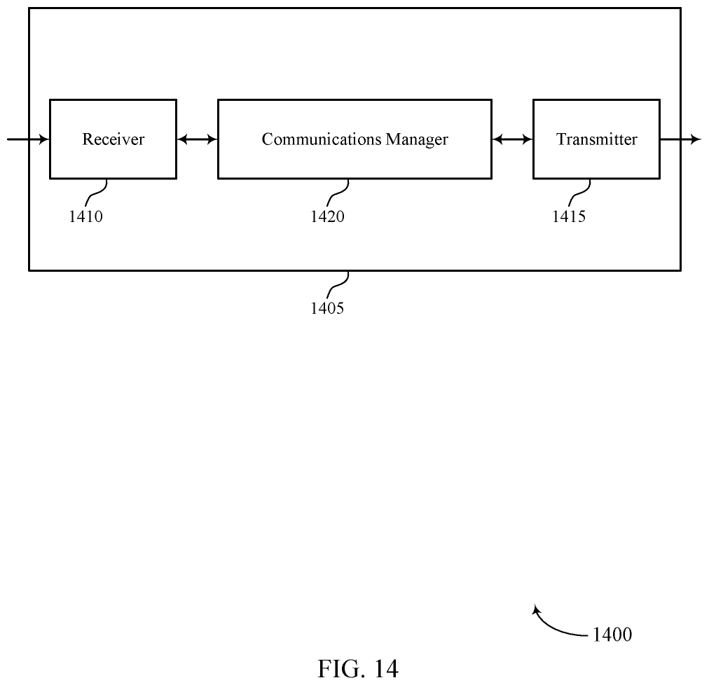

FIG. 14 shows a block diagram 1400 of a device 1405 that supports segment based feedback codebook in accordance with one or more aspects of the present disclosure. The device 1405 may be an example of aspects of a network entity 105 as described herein. The device 1405 may include a receiver 1410, a transmitter 1415, and a communications manager 1420. The device 1405, or one or more components of the device 1405 (e.g., the receiver 1410, the transmitter 1415, and the communications manager 1420), may include at least one processor, which may be coupled with at least one memory, to, individually or collectively, support or enable the described techniques. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of segment based feedback codebook as described herein. For example, the communications manager 1420, the receiver 1410, the transmitter 1415, or various combinations or components thereof may be capable of performing one or more of the functions described herein.

In some examples, the communications manager 1420, the receiver 1410, the transmitter 1415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1420, the receiver 1410, the transmitter 1415, or various combinations or components thereof may be implemented in code (e.g., as communications management software or firmware) executed by at least one processor. If implemented in code executed by at least one processor, the functions of the communications manager 1420, the receiver 1410, the transmitter 1415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications in accordance with examples as disclosed herein. For example, the communications manager 1420 is capable of, configured to, or operable to support a means for transmitting control signaling to report feedback information for a segment of resources, the segment being associated with one bit of the feedback information including an acknowledgment bit or a negative-acknowledgment bit of a hybrid automatic repeat request feedback. The communications manager 1420 is capable of, configured to, or operable to support a means for receiving a feedback codebook associated with a set of multiple segments based on the control signaling, the feedback codebook including the one bit of the feedback information associated with the segment according to the feedback codebook.

By including or configuring the communications manager 1420 in accordance with examples as described herein, the device 1405 (e.g., at least one processor controlling or otherwise coupled with the receiver 1410, the transmitter 1415, the communications manager 1420, or a combination thereof) may support techniques for more flexible and responsive communication and more efficient utilization of communication resources

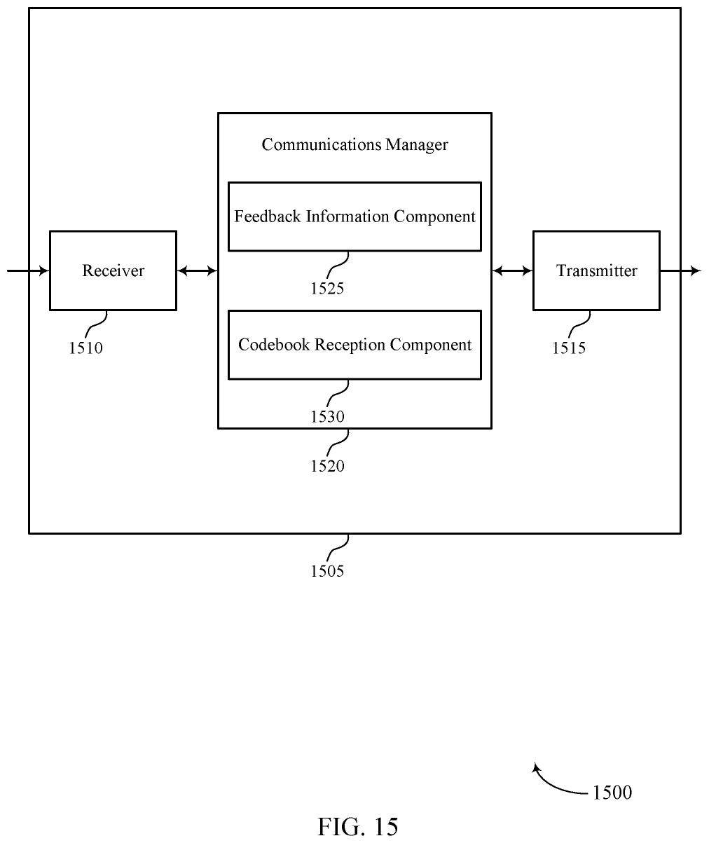

FIG. 15 shows a block diagram 1500 of a device 1505 that supports segment based feedback codebook in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505, or one of more components of the device 1505 (e.g., the receiver 1510, the transmitter 1515, and the communications manager 1520), may include at least one processor, which may be coupled with at least one memory, to support the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of segment based feedback codebook as described herein. For example, the communications manager 1520 may include a feedback information component 1525 a codebook reception component 1530, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with examples as disclosed herein. The feedback information component 1525 is capable of, configured to, or operable to support a means for transmitting control signaling to report feedback information for a segment of resources, the segment being associated with one bit of the feedback information including an acknowledgment bit or a negative-acknowledgment bit of a hybrid automatic repeat request feedback. The codebook reception component 1530 is capable of, configured to, or operable to support a means for receiving a feedback codebook associated with a set of multiple segments based on the control signaling, the feedback codebook including the one bit of the feedback information associated with the segment according to the feedback codebook.

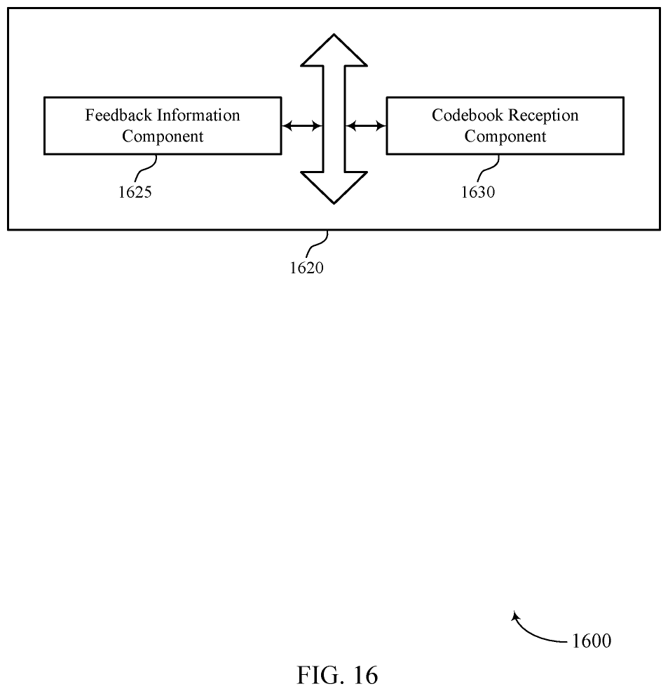

FIG. 16 shows a block diagram 1600 of a communications manager 1620 that supports segment based feedback codebook in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of segment based feedback codebook as described herein. For example, the communications manager 1620 may include a feedback information component 1625 a codebook reception component 1630, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications in accordance with examples as disclosed herein. The feedback information component 1625 is capable of, configured to, or operable to support a means for transmitting control signaling to report feedback information for a segment of resources, the segment being associated with one bit of the feedback information including an acknowledgment bit or a negative-acknowledgment bit of a hybrid automatic repeat request feedback. The codebook reception component 1630 is capable of, configured to, or operable to support a means for receiving a feedback codebook associated with a set of multiple segments based on the control signaling, the feedback codebook including the one bit of the feedback information associated with the segment according to the feedback codebook.

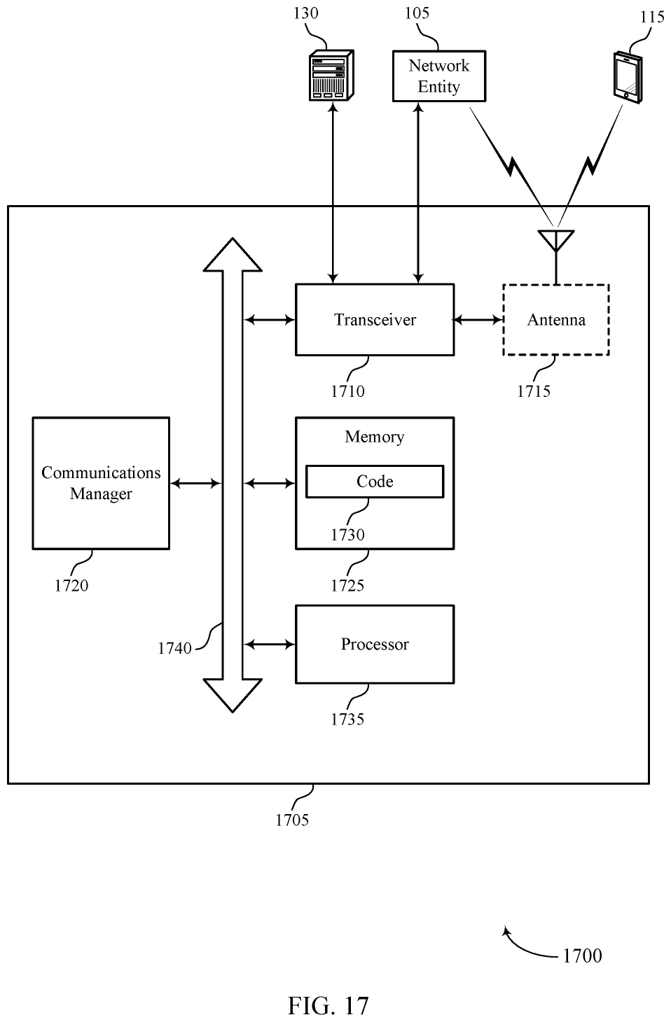

FIG. 17 shows a diagram of a system 1700 including a device 1705 that supports segment based feedback codebook in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, at least one memory 1725, code 1730, and at least one processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or one or more memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or one or more memory components (e.g., the at least one processor 1735, the at least one memory 1725, or both), may be included in a chip or chip assembly that is installed in the device 1705. In some examples, the transceiver 1710 may be operable to support communications via one or more communications links (e.g., a communication link 125, a backhaul communication link 120, a midhaul communication link 162, a fronthaul communication link 168).

The at least one memory 1725 may include RAM, ROM, or any combination thereof. The at least one memory 1725 may store computer-readable, computer-executable code 1730 including instructions that, when executed by one or more of the at least one processor 1735, cause the device 1705 to perform various functions described herein. The code 1730 may be stored in a non-transitory computer-readable medium such as system memory or another type of memory. In some cases, the code 1730 may not be directly executable by a processor of the at least one processor 1735 but may cause a computer (e.g., when compiled and executed) to perform functions described herein. In some cases, the at least one memory 1725 may contain, among other things, a BIOS which may control basic hardware or software operation such as the interaction with peripheral components or devices. In some examples, the at least one processor 1735 may include multiple processors and the at least one memory 1725 may include multiple memories. One or more of the multiple processors may be coupled with one or more of the multiple memories which may, individually or collectively, be configured to perform various functions herein (for example, as part of a processing system).

The at least one processor 1735 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1735 may be configured to operate a memory array using a memory controller. In some other cases, a memory controller may be integrated into one or more of the at least one processor 1735. The at least one processor 1735 may be configured to execute computer-readable instructions stored in a memory (e.g., one or more of the at least one memory 1725) to cause the device 1705 to perform various functions (e.g., functions or tasks supporting segment based feedback codebook). For example, the device 1705 or a component of the device 1705 may include at least one processor 1735 and at least one memory 1725 coupled with one or more of the at least one processor 1735, the at least one processor 1735 and the at least one memory 1725 configured to perform various functions described herein. The at least one processor 1735 may be an example of a cloud-computing platform (e.g., one or more physical nodes and supporting software such as operating systems, virtual machines, or container instances) that may host the functions (e.g., by executing code 1730) to perform the functions of the device 1705. The at least one processor 1735 may be any one or more suitable processors capable of executing scripts or instructions of one or more software programs stored in the device 1705 (such as within one or more of the at least one memory 1725). In some implementations, the at least one processor 1735 may be a component of a processing system. A processing system may generally refer to a system or series of machines or components that receives inputs and processes the inputs to produce a set of outputs (which may be passed to other systems or components of, for example, the device 1705). For example, a processing system of the device 1705 may refer to a system including the various other components or subcomponents of the device 1705, such as the at least one processor 1735, or the transceiver 1710, or the communications manager 1720, or other components or combinations of components of the device 1705. The processing system of the device 1705 may interface with other components of the device 1705, and may process information received from other components (such as inputs or signals) or output information to other components. For example, a chip or modem of the device 1705 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1705 may transmit information output from the chip or modem. Additionally, or alternatively, in some implementations, the one or more interfaces may refer to an interface between the processing system of the chip or modem and a receiver, such that the device 1705 may obtain information or signal inputs, and the information may be passed to the processing system. A person having ordinary skill in the art will readily recognize that a first interface also may obtain information or signal inputs, and a second interface also may output information or signal outputs.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the at least one memory 1725, the code 1730, and the at least one processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communications in accordance with examples as disclosed herein. For example, the communications manager 1720 is capable of, configured to, or operable to support a means for transmitting control signaling to report feedback information for a segment of resources, the segment being associated with one bit of the feedback information including an acknowledgment bit or a negative-acknowledgment bit of a hybrid automatic repeat request feedback. The communications manager 1720 is capable of, configured to, or operable to support a means for receiving a feedback codebook associated with a set of multiple segments based on the control signaling, the feedback codebook including the one bit of the feedback information associated with the segment according to the feedback codebook.

By including or configuring the communications manager 1720 in accordance with examples as described herein, the device 1705 may support techniques for improved user experience related to reduced processing, more efficient utilization of communication resources, improved coordination between devices, improved utilization of processing capability.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, one or more of the at least one processor 1735, one or more of the at least one memory 1725, the code 1730, or any combination thereof (for example, by a processing system including at least a portion of the at least one processor 1735, the at least one memory 1725, the code 1730, or any combination thereof). For example, the code 1730 may include instructions executable by one or more of the at least one processor 1735 to cause the device 1705 to perform various aspects of segment based feedback codebook as described herein, or the at least one processor 1735 and the at least one memory 1725 may be otherwise configured to, individually or collectively, perform or support such operations.

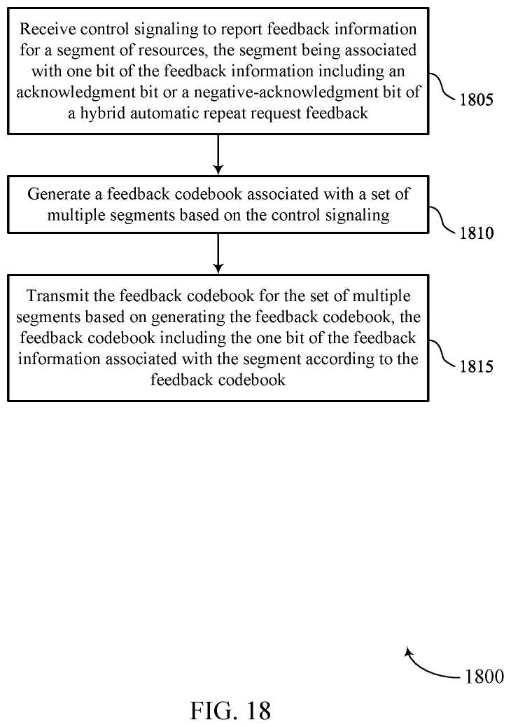

FIG. 18 shows a flowchart illustrating a method 1800 that supports segment based feedback codebook in accordance with aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving control signaling to report feedback information for a segment of resources, the segment being associated with one bit of the feedback information including an acknowledgment bit or a negative-acknowledgment bit of a hybrid automatic repeat request feedback. The operations of block 1805 may be performed in accordance with examples as disclosed herein. In some examples, aspects of the operations of 1805 may be performed by a feedback information component 1225 as described with reference to FIG. 12.

At 1810, the method may include generating a feedback codebook associated with a set of multiple segments based on the control signaling. The operations of block 1810 may be performed in accordance with examples as disclosed herein. In some examples, aspects of the operations of 1810 may be performed by a codebook generation component 1230 as described with reference to FIG. 12.

At 1815, the method may include transmitting the feedback codebook for the set of multiple segments based on generating the feedback codebook, the feedback codebook including the one bit of the feedback information associated with the segment according to the feedback codebook. The operations of block 1815 may be performed in accordance with examples as disclosed herein. In some examples, aspects of the operations of 1815 may be performed by a codebook transmission component 1235 as described with reference to FIG. 12.

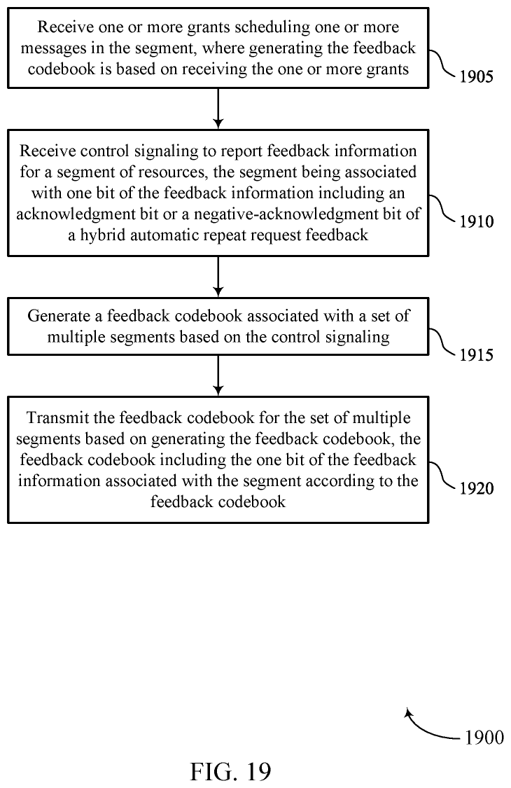

FIG. 19 shows a flowchart illustrating a method 1900 that supports segment based feedback codebook in accordance with aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include receiving one or more grants scheduling one or more messages in the segment, where generating the feedback codebook is based on receiving the one or more grants. The operations of block 1905 may be performed in accordance with examples as disclosed herein. In some examples, aspects of the operations of 1905 may be performed by a grant component 1240 as described with reference to FIG. 12.

At 1910, the method may include receiving control signaling to report feedback information for a segment of resources, the segment being associated with one bit of the feedback information including an acknowledgment bit or a negative-acknowledgment bit of a hybrid automatic repeat request feedback. The operations of block 1910 may be performed in accordance with examples as disclosed herein. In some examples, aspects of the operations of 1910 may be performed by a feedback information component 1225 as described with reference to FIG. 12.

At 1915, the method may include generating a feedback codebook associated with a set of multiple segments based on the control signaling. The operations of block 1915 may be performed in accordance with examples as disclosed herein. In some examples, aspects of the operations of 1915 may be performed by a codebook generation component 1230 as described with reference to FIG. 12.

At 1920, the method may include transmitting the feedback codebook for the set of multiple segments based on generating the feedback codebook, the feedback codebook including the one bit of the feedback information associated with the segment according to the feedback codebook. The operations of block 1920 may be performed in accordance with examples as disclosed herein. In some examples, aspects of the operations of 1920 may be performed by a codebook transmission component 1235 as described with reference to FIG. 12.

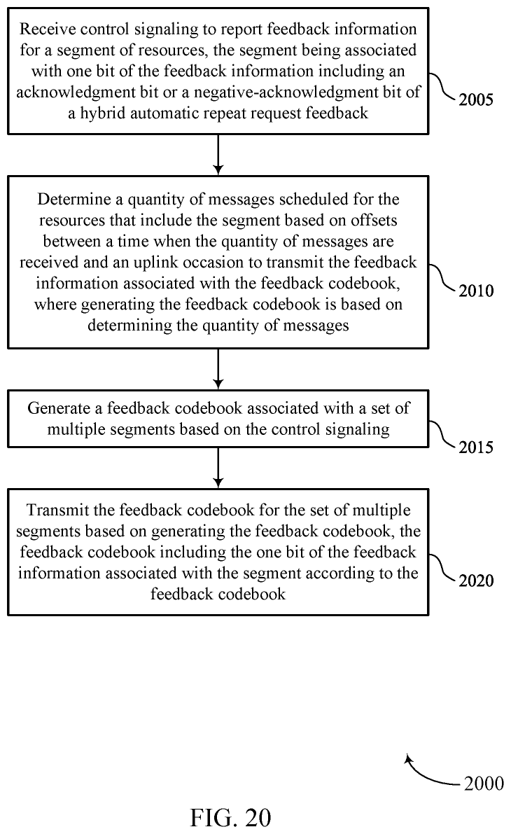

FIG. 20 shows a flowchart illustrating a method 2000 that supports segment based feedback codebook in accordance with aspects of the present disclosure. The operations of the method 2000 may be implemented by a UE or its components as described herein. For example, the operations of the method 2000 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 2005, the method may include receiving control signaling to report feedback information for a segment of resources, the segment being associated with one bit of the feedback information including an acknowledgment bit or a negative-acknowledgment bit of a hybrid automatic repeat request feedback. The operations of block 2005 may be performed in accordance with examples as disclosed herein. In some examples, aspects of the operations of 2005 may be performed by a feedback information component 1225 as described with reference to FIG. 12.

At 2010, the method may include determining a quantity of messages scheduled for the resources that include the segment based on offsets between a time when the quantity of messages are received and an uplink occasion to transmit the feedback information associated with the feedback codebook, where generating the feedback codebook is based on determining the quantity of messages. The operations of block 2010 may be performed in accordance with examples as disclosed herein. In some examples, aspects of the operations of 2010 may be performed by a scheduled messages component 1245 as described with reference to FIG. 12.

At 2015, the method may include generating a feedback codebook associated with a set of multiple segments based on the control signaling. The operations of block 2015 may be performed in accordance with examples as disclosed herein. In some examples, aspects of the operations of 2015 may be performed by a codebook generation component 1230 as described with reference to FIG. 12.

At 2020, the method may include transmitting the feedback codebook for the set of multiple segments based on generating the feedback codebook, the feedback codebook including the one bit of the feedback information associated with the segment according to the feedback codebook. The operations of block 2020 may be performed in accordance with examples as disclosed herein. In some examples, aspects of the operations of 2020 may be performed by a codebook transmission component 1235 as described with reference to FIG. 12.

The following provides an overview of aspects of the present disclosure:

Aspect 1: A method for wireless communications by a UE, comprising: receiving control signaling to report feedback information for a segment of resources, the segment being associated with one bit of the feedback information comprising an acknowledgment bit or a negative-acknowledgment bit of a hybrid automatic repeat request feedback; generating a feedback codebook associated with a plurality of segments based at least in part on the control signaling; and transmitting the feedback codebook for the plurality of segments based at least in part on generating the feedback codebook, the feedback codebook comprising the one bit of the feedback information associated with the segment according to the feedback codebook.

Aspect 2: The method of aspect 1, further comprising: receiving one or more grants scheduling one or more messages in the segment, wherein generating the feedback codebook is based at least in part on receiving the one or more grants.

Aspect 3: The method of any of aspects 1 through 2, further comprising: determining a quantity of messages scheduled for the resources that comprise the segment based at least in part on offsets between a time when the quantity of messages are received and an uplink occasion to transmit the feedback information associated with the feedback codebook, wherein generating the feedback codebook is based at least in part on determining the quantity of messages.

Aspect 4: The method of aspect 3, wherein the one bit of the feedback information associated with the segment comprises information for the quantity of the messages.

Aspect 5: The method of any of aspects 3 through 4, wherein transmitting the feedback codebook further comprises: transmitting the one bit of the feedback information comprising the acknowledgment bit if each of the quantity of messages are successfully decoded.

Aspect 6: The method of any of aspects 3 through 5, wherein transmitting the feedback codebook further comprises: transmitting the one bit of the feedback information comprising the negative-acknowledgment bit if at least one of the quantity of messages fails to be successfully decoded.

Aspect 7: The method of any of aspects 1 through 6, wherein generating the feedback codebook further comprises: determining a discontinuity of values of downlink assignment index indicators received as part of grants; and assigning a negative acknowledgement to the segment in the feedback codebook based at least in part on determining the discontinuity of the values.

Aspect 8: The method of any of aspects 1 through 7, further comprising: receiving a grant for a first message to be communicated during the segment, the grant comprising a first downlink assignment index indicator associated with the segment, wherein generating the feedback codebook is based at least in part on the first downlink assignment index indicator.

Aspect 9: The method of aspect 8, further comprising: receiving a second grant for a second message to be communicated during the segment, the second grant comprising a second downlink assignment index indicator associated with the segment and different than the first downlink assignment index indicator; and receiving a third grant for a third message to be communicated during the segment, the third grant comprising a third downlink assignment index indicator associated with the segment and different than the first downlink assignment index indicator and the second downlink assignment index indicator.

Aspect 10: The method of any of aspects 1 through 9, further comprising: determining a start parameter and a length parameter for a message scheduled to be communicated via the resources that comprise the segment, wherein generating the feedback codebook is based at least in part on determining the start parameter and the length parameter.

Aspect 11: The method of any of aspects 1 through 10, further comprising: determining whether a quantity of grants received for the resources that comprise the segment satisfies a threshold, wherein generating the feedback codebook is based at least in part on determining whether the quantity of grants received satisfies the threshold.

Aspect 12: The method of any of aspects 1 through 11, further comprising: determining whether a message scheduled to be communicated via the resources that comprise the segment was not successfully detected, wherein generating the feedback codebook is based at least in part on determining whether the message was not successfully detected.

Aspect 13: The method of any of aspects 1 through 12, further comprising: receiving second control signaling comprising an indication of a maximum quantity of messages capable of being scheduled to be communicated via the resources that comprise the segment, wherein generating the feedback codebook is based at least in part on receiving the second control signaling.

Aspect 14: The method of aspect 13, further comprising: transmitting signaling to indicate a maximum quantity of messages that the UE can support being scheduled in the resources that comprise the segment, wherein receiving the second control signaling is based at least in part on transmitting the signaling.

Aspect 15: The method of any of aspects 1 through 14, further comprising: receiving second control signaling comprising an indication of a maximum quantity of grants capable of scheduling messages to be communicated via the resources that comprise the segment, wherein generating the feedback codebook is based at least in part on receiving the second control signaling.

Aspect 16: The method of any of aspects 1 through 15, wherein receiving the control signaling further comprises: receiving a grant for a first message to be communicated during the segment, the grant comprising a message quantity indicator associated with a quantity of messages scheduled to be communicated via the resources that comprise the segment, wherein generating the feedback codebook is based at least in part on the message quantity indicator.

Aspect 17: The method of aspect 16, wherein receiving the control signaling further comprises: receiving a grant for a first message to be communicated during the segment, the grant comprising a segment index indicator associated with the segment and a message quantity indicator associated with a quantity of messages scheduled to be communicated via the resources that comprise the segment; and receiving a second grant for a second message to be communicated during the segment, the second grant comprising the segment index indicator and the message quantity indicator, wherein generating the feedback codebook is based at least in part on the segment index indicator and the message quantity indicator.

Aspect 18: The method of any of aspects 1 through 17, wherein the resources that comprise the segment are defined over time domain resources and one or more component carriers of a plurality of component carriers.

Aspect 19: The method of aspect 18, further comprising: receiving second control signaling to report the feedback information for a second segment of resources, the resources that comprise the second segment are defined over second time domain resources that at least partially overlaps with the time domain resources and at least one component carrier different than the one or more component carriers, wherein generating the feedback codebook is based at least in part on the second control signaling.

Aspect 20: The method of any of aspects 18 through 19, further comprising: generating a feedback codebook of dynamic length, wherein generating the feedback codebook is based at least in part on generating the feedback codebook of dynamic length.

Aspect 21: The method of aspect 20, wherein generating the feedback codebook of dynamic length further comprises: receiving one or more grants scheduling one or more messages in the plurality of segments, the one or more grants comprising a segment index indicator; determining a discontinuity of values of segment index indicators received as part of grants; and assigning a negative acknowledgement to at least one segment in the feedback codebook based at least in part on determining the discontinuity of the values.

Aspect 22: The method of any of aspects 1 through 21, wherein a plurality of messages is received via the resources that comprise the segment.

Aspect 23: The method of any of aspects 1 through 22, wherein the segment comprises one or more slots, one or more portions of a slot, or a combination thereof.

Aspect 24: The method of any of aspects 1 through 23, wherein a first size of a first segment is different than a second size of a second segment.

Aspect 25: The method of any of aspects 1 through 24, wherein the resources that comprise the segment are defined by a slot index, a symbol index, or any combination thereof.

Aspect 26: The method of any of aspects 1 through 25, wherein the resources that comprise the segment are defined by a physical uplink control channel transmission occasion.

Aspect 27: The method of any of aspects 1 through 26, wherein the resources that comprise the segment are associated with a time domain, a frequency domain, or any combination thereof.

Aspect 28: A method for wireless communications at a network entity, comprising: transmitting control signaling to report feedback information for a segment of resources, the segment being associated with one bit of the feedback information comprising an acknowledgment bit or a negative-acknowledgment bit of a hybrid automatic repeat request feedback; and receiving a feedback codebook associated with a plurality of segments based at least in part on the control signaling, the feedback codebook comprising the one bit of the feedback information associated with the segment according to the feedback codebook.

Aspect 29: A UE for wireless communications, comprising one or more memories storing processor-executable code, and one or more processors coupled with the one or more memories and individually or collectively operable to execute the code to cause the UE to perform a method of any of aspects 1 through 27.

Aspect 30: A UE for wireless communications, comprising at least one means for performing a method of any of aspects 1 through 27.

Aspect 31: A non-transitory computer-readable medium storing code for wireless communications, the code comprising instructions executable by a processor to perform a method of any of aspects 1 through 27.

Aspect 32: A network entity for wireless communications, comprising one or more memories storing processor-executable code, and one or more processors coupled with the one or more memories and individually or collectively operable to execute the code to cause the network entity to perform a method of aspect 28.

Aspect 33: A network entity for wireless communications, comprising at least one means for performing a method of aspect 28.

Aspect 34: A non-transitory computer-readable medium storing code for wireless communications, the code comprising instructions executable by a processor to perform a method of aspect 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling to report feedback information for a segment of resources, the segment being associated with one bit of the feedback information comprising an acknowledgment bit or a negative-acknowledgment bit of a hybrid automatic repeat request feedback;
generate a feedback codebook associated with a plurality of segments based at least in part on the control signaling; and
transmit the feedback codebook for the plurality of segments based at least in part on generating the feedback codebook, the feedback codebook comprising the one bit of the feedback information associated with the segment according to the feedback codebook.

2. The UE of claim 1, wherein the one or more processors are individually or collectively further operable to execute the code to cause the UE to:
receive one or more grants scheduling one or more messages in the segment, wherein generating the feedback codebook is based at least in part on receiving the one or more grants.

3. The UE of claim 1, wherein the one or more processors are individually or collectively further operable to execute the code to cause the UE to:
determine a quantity of messages scheduled for the resources that comprise the segment based at least in part on offsets between a time when the quantity of messages are received and an uplink occasion to transmit the feedback information associated with the feedback codebook, wherein generating the feedback codebook is based at least in part on determining the quantity of messages.

4. The UE of claim 3, wherein the one bit of the feedback information associated with the segment comprises information for the quantity of the messages.

5. The UE of claim 3, wherein, to transmit the feedback codebook, the one or more processors are individually or collectively further operable to execute the code to cause the UE to:
transmit the one bit of the feedback information comprising the acknowledgment bit if each of the quantity of messages are successfully decoded.

6. The UE of claim 3, wherein, to transmit the feedback codebook, the one or more processors are individually or collectively further operable to execute the code to cause the UE to:
transmit the one bit of the feedback information comprising the negative-acknowledgment bit if at least one of the quantity of messages fails to be successfully decoded.

7. The UE of claim 1, wherein, to generate the feedback codebook, the one or more processors are individually or collectively further operable to execute the code to cause the UE to:
determine a discontinuity of values of downlink assignment index indicators received as part of grants; and
assign a negative acknowledgement to the segment in the feedback codebook based at least in part on determining the discontinuity of the values.

8. The UE of claim 1, wherein the one or more processors are individually or collectively further operable to execute the code to cause the UE to:
receive a grant for a first message to be communicated during the segment, the grant comprising a first downlink assignment index indicator associated with the segment, wherein generating the feedback codebook is based at least in part on the first downlink assignment index indicator.

9. The UE of claim 8, wherein the one or more processors are individually or collectively further operable to execute the code to cause the UE to:
receive a second grant for a second message to be communicated during the segment, the second grant comprising a second downlink assignment index indicator associated with the segment and different than the first downlink assignment index indicator; and
receive a third grant for a third message to be communicated during the segment, the third grant comprising a third downlink assignment index indicator associated with the segment and different than the first downlink assignment index indicator and the second downlink assignment index indicator.

10. The UE of claim 1, wherein the one or more processors are individually or collectively further operable to execute the code to cause the UE to:
determine a start parameter and a length parameter for a message scheduled to be communicated via the resources that comprise the segment, wherein generating the feedback codebook is based at least in part on determining the start parameter and the length parameter.

11. The UE of claim 1, wherein the one or more processors are individually or collectively further operable to execute the code to cause the UE to:
determine whether a quantity of grants received for the resources that comprise the segment satisfies a threshold, wherein generating the feedback codebook is based at least in part on determining whether the quantity of grants received satisfies the threshold.

12. The UE of claim 1, wherein the one or more processors are individually or collectively further operable to execute the code to cause the UE to:
determine whether a message scheduled to be communicated via the resources that comprise the segment was not successfully detected, wherein generating the feedback codebook is based at least in part on determining whether the message was not successfully detected.

13. The UE of claim 1, wherein the one or more processors are individually or collectively further operable to execute the code to cause the UE to:
receive second control signaling comprising an indication of a maximum quantity of messages capable of being scheduled to be communicated via the resources that comprise the segment, wherein generating the feedback codebook is based at least in part on receiving the second control signaling.

14. The UE of claim 13, wherein the one or more processors are individually or collectively further operable to execute the code to cause the UE to:
transmit signaling to indicate a maximum quantity of messages that the UE can support being scheduled in the resources that comprise the segment, wherein receiving the second control signaling is based at least in part on transmitting the signaling.

15. The UE of claim 1, wherein the one or more processors are individually or collectively further operable to execute the code to cause the UE to:
receive second control signaling comprising an indication of a maximum quantity of grants capable of scheduling messages to be communicated via the resources that comprise the segment, wherein generating the feedback codebook is based at least in part on receiving the second control signaling.

16. The UE of claim 1, wherein, to receive the control signaling, the one or more processors are individually or collectively further operable to execute the code to cause the UE to:
receive a grant for a first message to be communicated during the segment, the grant comprising a message quantity indicator associated with a quantity of messages scheduled to be communicated via the resources that comprise the segment, wherein generating the feedback codebook is based at least in part on the message quantity indicator.

17. The UE of claim 16, wherein, to receive the control signaling, the one or more processors are individually or collectively further operable to execute the code to cause the UE to:
receive the grant for the first message to be communicated during the segment, the grant comprising a segment index indicator associated with the segment and the message quantity indicator associated with the quantity of messages scheduled to be communicated via the resources that comprise the segment; and
receive a second grant for a second message to be communicated during the segment, the second grant comprising the segment index indicator and the message quantity indicator, wherein generating the feedback codebook is based at least in part on the segment index indicator and the message quantity indicator.

18. The UE of claim 1, wherein the resources that comprise the segment are defined over time domain resources and one or more component carriers of a plurality of component carriers.

19. The UE of claim 18, wherein the one or more processors are individually or collectively further operable to execute the code to cause the UE to:
receive second control signaling to report the feedback information for a second segment of resources, the resources that comprise the second segment are defined over second time domain resources that at least partially overlaps with the time domain resources and at least one component carrier different than the one or more component carriers, wherein generating the feedback codebook is based at least in part on the second control signaling.

20. The UE of claim 18, wherein the one or more processors are individually or collectively further operable to execute the code to cause the UE to:
generate a feedback codebook of dynamic length, wherein generating the feedback codebook is based at least in part on generating the feedback codebook of dynamic length.

21. The UE of claim 20, wherein, to generate the feedback codebook of dynamic length, the one or more processors are individually or collectively further operable to execute the code to cause the UE to:
receive one or more grants scheduling one or more messages in the plurality of segments, the one or more grants comprising a segment index indicator;
determine a discontinuity of values of segment index indicators received as part of grants; and
assign a negative acknowledgement to at least one segment in the feedback codebook based at least in part on determining the discontinuity of the values.

22. The UE of claim 1, wherein a plurality of messages is received via the resources that comprise the segment.

23. The UE of claim 1, wherein the segment comprises one or more slots, one or more portions of a slot, or a combination thereof.

24. The UE of claim 1, wherein a first size of a first segment is different than a second size of a second segment.

25. The UE of claim 1, wherein the resources that comprise the segment are defined by a slot index, a symbol index, or any combination thereof.

26. The UE of claim 1, wherein the resources that comprise the segment are defined by a physical uplink control channel transmission occasion.

27. The UE of claim 1, wherein the resources that comprise the segment are associated with a time domain, a frequency domain, or any combination thereof.

28. A network entity, comprising:
one or more memories storing processor-executable code; and
one or more processors coupled with the one or more memories and individually or collectively operable to execute the code to cause the network entity to:
transmit control signaling to report feedback information for a segment of resources, the segment being associated with one bit of the feedback information comprising an acknowledgment bit or a negative-acknowledgment bit of a hybrid automatic repeat request feedback; and
receive a feedback codebook associated with a plurality of segments based at least in part on the control signaling, the feedback codebook comprising the one bit of the feedback information associated with the segment according to the feedback codebook.

29. A method for wireless communications by a user equipment (UE), comprising:
receiving control signaling to report feedback information for a segment of resources, the segment being associated with one bit of the feedback information comprising an acknowledgment bit or a negative-acknowledgment bit of a hybrid automatic repeat request feedback;
generating a feedback codebook associated with a plurality of segments based at least in part on the control signaling; and
transmitting the feedback codebook for the plurality of segments based at least in part on generating the feedback codebook, the feedback codebook comprising the one bit of the feedback information associated with the segment according to the feedback codebook.

30. A method for wireless communications at a network entity, comprising:
transmitting control signaling to report feedback information for a segment of resources, the segment being associated with one bit of the feedback information comprising an acknowledgment bit or a negative-acknowledgment bit of a hybrid automatic repeat request feedback; and
receiving a feedback codebook associated with a plurality of segments based at least in part on the control signaling, the feedback codebook comprising the one bit of the feedback information associated with the segment according to the feedback codebook.
